(19) United States
(12) Patent Application Publication
(10) Pub. No.: US 2026/0265885 A1
(43) Pub. Date: Sep. 10, 2026

(54) HOT-DIP GALVANIZED STEEL SHEET, MEMBER FORMED USING HOT-DIP GALVANIZED STEEL SHEET, AUTOMOBILE FRAME STRUCTURAL COMPONENT OR AUTOMOBILE REINFORCEMENT COMPONENT COMPRISING MEMBER, AND METHOD FOR PRODUCING HOT-DIP GALVANIZED STEEL SHEET AND MEMBER

(71) Applicant: JFE STEEL CORPORATION, Chiyoda-ku, Tokyo (JP)

(72) Inventors: Hidekazu MINAMI, Chiyoda-ku, Tokyo (JP); Yoshiyasu KAWASAKI, Chiyoda-ku, Tokyo (JP); Yuki TOJI, Chiyoda-ku, Tokyo (JP); Yusuke WADA, Chiyoda-ku, Tokyo (JP)

(73) Assignee: JFE STEEL CORPORATION, Chiyoda-ku, Tokyo (JP)

(21) Appl. No.: 19/166,040

(22) PCT Filed: Apr. 6, 2023
(86) PCT No.: PCT/JP2023/014289

§ 371 Date: Sep. 17, 2025

(51) Int. Cl. C22C 38/04; B62D 29/00; C21D 6/00; C21D 8/0221; C21D 8/0247; C21D 8/04; C21D 9/46; C22C 38/00; C22C 38/02; C22C 38/06; C23C 2/06; C23C 2/28

(52) U.S. Cl. CPC C22C 38/04; B62D 29/007; C21D 6/005; C21D 8/0226; C21D 8/0236; C21D 8/0273; C21D 8/0478; C21D 9/46; C22C 38/001; C22C 38/002; C22C 38/02; C22C 38/06; C23C 2/06; C23C 2/28; C21D 2211/001; C21D 2211/005; C21D 2211/008

(57) ABSTRACT

A 980 MPa or more hot-dip galvanized steel sheet with high ductility, high stretch flangeability, bendability, and high local ductility, is provided. The sheet includes a base steel sheet and a hot-dip galvanized layer and has a predetermined chemical composition and a steel structure such that at a ¼ thickness position of the base steel sheet, an area ratio is 30% or more for martensite, 70% or less for ferrite, and 10% or less for retained austenite, and in a region up to a depth of 10 μm from the surface, the area ratio of martensite is 5% or more, and the area ratio of martensite is 80% or less of the area ratio of martensite at the ¼ thickness position of the base steel sheet. A diffusible hydrogen content in a low temperature region within the base steel sheet is 0.015 mass ppm or less.

### TECHNICAL FIELD

The present disclosure relates to a hot-dip galvanized steel sheet, a member formed using a hot-dip galvanized steel sheet, an automobile frame structural component or automobile reinforcement component comprising the member, and a method of producing the hot-dip galvanized steel sheet and the member.

### BACKGROUND

In order to reduce CO₂ emissions through vehicle weight reduction while improving crashworthiness, advances are being made in strengthening steel sheets for automobiles. In addition, against the backdrop of the continuous introduction of new regulations, there has been an increasing number of cases in which high strength steel sheets are applied to major structural components and reinforcement parts that form the framework of an automobile cabin (hereinafter also referred to as “automobile frame structural components” or the like) in order to strengthen the automotive body. In particular, there has been an increase in the application of high strength steel sheets with a tensile strength (hereinafter also referred to as “TS”) of 980 MPa or more.

High strength steel sheets used in automobile frame structural components and the like are required to have high stretch flangeability when formed into the desired shape.

Furthermore, among automobile frame structural components, for example, crash boxes and the like have bending sections. Therefore, steel sheets with a high bendability are preferably applied to such components from the perspective of formability.

As technology related to such high strength steel sheets, for example, claim 1 of Patent Literature (PTL) 1 recites “a high strength hot-dip galvanized steel sheet comprising a base steel sheet and a hot-dip galvanized layer formed on the surface of the base steel sheet, having a tensile strength of 780 MPa or more, wherein the base steel sheet comprises a chemical composition containing, in mass %, C: 0.050% or more and 0.200% or less, Si: 0.10% or more and 0.90% or less, Mn: 2.00% or more and 3.50% or less, P: 0.001% or more and 0.100% or less, S: 0.0200% or less, Al: 1.000% or less, N: 0.0100% or less, Ca: 0.0200% or less, and Cr: 0.300% or less, the chemical composition satisfying the relationship of [% Mn]/[% Si] being 2.9 or more and 11.7 or less, the balance being Fe and inevitable impurities, wherein the base steel sheet has a steel structure in which one or more types selected from the group consisting of bainite and ferrite have a total area ratio of 5% or more and 85% or less, the area ratio of tempered martensite is 65% or less, the area ratio of quenched martensite is 5% or more and 40% or less, and the volume fraction of retained austenite is 5.0% or less, and wherein the ratio of the Si concentration to the Mn concentration in the surface layer of the base steel sheet is 0.7 or more and 1.3 or less, and the diffusible hydrogen content in the base steel sheet is 0.80 mass ppm or less, where [% Mn] and [% Si] indicate the content of Mn and Si in steel (mass %)”.

### CITATION LIST

### Patent Literature

PTL 1: WO 2020/170542 A1

### SUMMARY

### Technical Problem

However, the hot-dip galvanized steel sheet described in PTL 1 does not take into account ultimate deformability and local ductility. Therefore, from the perspective of increasing the application ratio of high strength steel sheets with TS of 980 MPa or more, especially hot-dip galvanized steel sheets, to automobile frame structural components and the like, demand currently exists for development of a hot-dip galvanized steel sheet with a TS of 980 MPa or more that has high ultimate deformability, high ductility, high stretch flangeability, and bendability, and also has high local ductility.

The present disclosure has been developed in view of the above circumstances and aims to provide a hot-dip galvanized steel sheet, with a TS of 980 MPa or more, that has high ultimate deformability, high ductility, high stretch flangeability, and bendability, along with high local ductility.

In addition, the present disclosure aims to provide a method of producing the above hot-dip galvanized steel sheet.

Furthermore, the present disclosure aims to provide a member formed using the above hot-dip galvanized steel sheet.

Here, “high ultimate deformability” means that the ultimate deformability measured by the evaluation method described later is 0.10 or more.

Here, “high ductility” means that the product (TS×El) of TS and total elongation (hereinafter also referred to as “El”) measured in accordance with JIS Z 2241 is 10000 MPa·% or more.

“High stretch flangeability” means that the hole expansion ratio (hereinafter also referred to as “λ”) measured in accordance with JIS Z 2256 is 20% or more.

“High bendability” means that in the bend test conducted in accordance with JIS Z 2248 (for details, refer to the EXAMPLES section below), none of the five samples cracks, or at least one of the five samples has a microfissure of less than 200 μm.

Here, “high local ductility” means that the product of TS and local elongation (hereinafter also referred to as “L·El”) measured in accordance with JIS Z 2241 is 4500 MPa·% or more.

### Solution to Problem

We intensely studied how to achieve the aforementioned objectives and made the following discoveries.
(1) The base steel sheet is provided with a predetermined chemical composition, and a steel structure including martensite (quenched martensite, tempered martensite, and bainite) is formed. As a result, TS: 980 MPa or more is obtained.
(2) By ensuring that the steel structure of the base steel sheet includes at least one of ferrite and retained austenite, high ductility is obtained.
(3) By ensuring that the area ratio of martensite in the region up to a depth of 10 μm from the surface of the base steel sheet is 5% or more, and that the area ratio of martensite at the ¼ thickness position of the base steel sheet is 80% or less, high ultimate deformability and high bendability are obtained.
(4) By reducing the diffusible hydrogen content in the low temperature region of the base steel sheet to 0.015 mass ppm or less, high local ductility, stretch flangeability, and bendability are obtained.

[1] A hot-dip galvanized steel sheet comprising a base steel sheet and a hot-dip galvanized layer on a surface of the base steel sheet, wherein
the base steel sheet comprises
a chemical composition containing (consisting of), in mass %,
C: 0.030% or more and 0.500% or less,
Si: 0.01% or more and 2.50% or less,
Mn: 0.10% or more and 5.00% or less,
P: 0.100% or less,
S: 0.0200% or less,
Al: 1.000% or less,
N: 0.0100% or less, and
O: 0.0100% or less,
with the balance being Fe and inevitable impurities, and
a steel structure such that at a ¼ thickness position of the base steel sheet,
an area ratio of martensite is 30% or more,
an area ratio of ferrite is 70% or less,
an area ratio of retained austenite is 10% or less,
at least one of ferrite and retained austenite is included, and
in a region up to a depth of 10 μm from the surface of the base steel sheet,
the area ratio of martensite is 5% or more, and the area ratio of martensite is 80% or less of the area ratio of martensite at the ¼ thickness position of the base steel sheet, and
a diffusible hydrogen content in a low temperature region within the base steel sheet is 0.015 mass ppm or less, the diffusible hydrogen content being an amount of hydrogen released when the base steel sheet is heated to 50° C.

[2] The hot-dip galvanized steel sheet according to [1], wherein the chemical composition further contains, by mass %, at least one selected from the group consisting of:
Ti: 0.200% or less,
Nb: 0.200% or less,
V: 0.200% or less,
Ta: 0.10% or less,
W: 0.10% or less,
B: 0.0100% or less,
Cr: 1.00% or less,
Mo: 1.00% or less,
Ni: 1.00% or less,
Co: 0.010% or less,
Cu: 1.00% or less,
Sn: 0.200% or less,
Sb: 0.200% or less,
Ca: 0.0100% or less,
Mg: 0.0100% or less,
REM: 0.0100% or less,
Zr: 0.100% or less,
Te: 0.100% or less,
Hf: 0.10% or less, and
Bi: 0.200% or less.

[3] The hot-dip galvanized steel sheet according to [1] or [2], wherein the hot-dip galvanized layer is a galvannealed layer.

[4] The hot-dip galvanized steel sheet according to any one of [1] to [3], wherein the base steel sheet comprises a surface soft layer that is a region having a Vickers hardness of 85% or less of a Vickers hardness at the ¼ thickness position of the base steel sheet and is a region within 200 μm from the surface of the base steel sheet in a thickness direction, and
when measuring nanohardness at 300 or more points in a 50 μm×50 μm region of a sheet surface at a ¼ depth position in the thickness direction and a ½ depth position in the thickness direction of the surface soft layer from the surface of the base steel sheet,
a ratio of a number of measurements with a nanohardness of the sheet surface of 7.0 GPa or more at the ¼ depth position in the thickness direction of the surface soft layer from the surface of the base steel sheet is 0.10 or less with respect to a total number of measurements,
a standard deviation σ of the nanohardness of the sheet surface at the ¼ depth position in the thickness direction of the surface soft layer from the surface of the base steel sheet is 1.8 GPa or less, and
a standard deviation σ of the nanohardness of the sheet surface at the ½ depth position in the thickness direction of the surface soft layer from the surface of the base steel sheet is 2.2 GPa or less.

[5] The hot-dip galvanized steel sheet according to any one of [1] to [4], comprising a metal coated or plated layer formed between the base steel sheet and the hot-dip galvanized layer on one side or both sides of the hot-dip galvanized steel sheet.

[6] A member formed using the hot-dip galvanized steel sheet according to any one of [1] to [5].

[7] An automobile frame structural component or automobile reinforcement component comprising the member according to [6].

[8] A method of producing a hot-dip galvanized steel sheet, the method comprising: subjecting a steel slab having the chemical composition of [1] or [2] to
hot rolling under a set of conditions including a coiling temperature of 400° C. or more and 700° C. or less to obtain a hot-rolled steel sheet;
subsequently subjecting the hot-rolled steel sheet to pickling;
subsequently subjecting the hot-rolled steel sheet to cold rolling under a set of conditions including a cumulative rolling reduction ratio of 30% or more and a unit tension of 10 kgf/mm² or more between a final pass and a pass immediately before the final pass to obtain a cold-rolled steel sheet;
subsequently heating the cold-rolled steel sheet to an annealing temperature T₁ of 750° C. or more and 950° C. or less with an oxygen concentration of 0.5 vol % or more and 5.0 vol % or less in a temperature range of 250° C. or more and 700° C. or less;
annealing the cold-rolled steel sheet under a set of conditions including setting a dew point to −30° C. or more in a temperature range above 700° C. and T₁ or less, and retaining the cold-rolled steel sheet for a retention time of 10 s or more and 500 s or less in the temperature range;
subsequently subjecting the cold-rolled steel sheet subjected to the annealing to hot-dip galvanizing treatment to obtain a coated steel sheet; and subsequently cooling the coated steel sheet to obtain a hot-dip galvanized steel sheet.

[9] The method of producing a hot-dip galvanized steel sheet according to [8], wherein during the cooling of the coated steel sheet, the coated steel sheet is held for 5 s or more in a temperature range of 100° C. or more and 450° C. or less and is then cooled.

The method of producing a hot-dip galvanized steel sheet according to [8], wherein during the cooling of the coated steel sheet, cooling is stopped at 300° C. or less, the coated steel sheet is subsequently reheated to a temperature range of cooling stop temperature+50° C. or more and 450° C. or less, is then held for 5 s or more, and is then cooled.

The method of producing a hot-dip galvanized steel sheet according to any one of [8] to [10], wherein after the hot-dip galvanizing treatment, the coated steel sheet is subjected to alloying treatment.

The method of producing a hot-dip galvanized steel sheet according to any one of [8] to [11], further comprising subjecting, before the annealing, one side or both sides of the cold-rolled steel sheet to metal coating or plating to form a metal coated or plated layer.

A method of producing a member, the method comprising subjecting the hot-dip galvanized steel sheet according to any one of [1] to [5] to at least one of forming processing and joining processing to form a member.

### Advantageous Effect

According to the present disclosure, it is possible to provide a 980 MPa or more hot-dip galvanized steel sheet and member that have high ultimate deformability, high ductility, high stretch flangeability, and bendability, as well as high local ductility, along with a method of producing the same.

### BRIEF DESCRIPTION OF THE DRAWINGS

In the accompanying drawings:

FIGS. 1A and 1B are schematic diagrams related to the production of a U-bend+close-bend test sample of the Examples, where FIG. 1A relates to U-bending processing (primary bending), and FIG. 1B relates to bending (secondary bending);

FIGS. 2A and 2B are schematic diagrams related to the production of a V-bend+orthogonal VDA bend test sample of the Examples, where FIG. 2A relates to V-bending processing (primary bending), and FIG. 2B relates to orthogonal VDA bending (secondary bending);

FIGS. 3A, 3B, and 3C are schematic diagrams related to an axial crushing test sample and test of the Examples, where FIG. 3A is a front view of a test member, FIG. 3B is a front view of the test member, and FIG. 3C is a schematic diagram illustrating the axial crushing test.

### DETAILED DESCRIPTION

The presently disclosed techniques will be described below by way of embodiments. The present disclosure is not limited to the following embodiments.

### [1] Hot-Dip Galvanized Steel Sheet

### [1-1] Base Steel Sheet

The hot-dip galvanized steel sheet of the present disclosure includes a base steel sheet and a hot-dip galvanized layer on a surface of the base steel sheet. First, the base steel sheet will be described.

### [1-1-1] Chemical Composition

The chemical composition of the base steel sheet will be described. The “%” representations below indicating the chemical composition of the steel sheet are in “mass %” unless stated otherwise. In the present specification, a numerical range expressed by using “to” means a range including numerical values described before and after “to”, as the lower limit value and the upper limit value.

### [C: 0.030% or More and 0.500% or Less]

C is one of the important basic components of steel, and particularly in the present disclosure, C is an important element that affects the area ratio of martensite and ferrite. If the C content is less than 0.030%, the fraction of martensite decreases, making it difficult to achieve the desired TS. On the other hand, if the C content exceeds 0.500%, the area ratio of retained austenite increases. Consequently, hydrogen desorption from the coated or plated steel sheet is not promoted, and the diffusible hydrogen content in the low temperature region of the base steel sheet increases, making it difficult to achieve the desired local ductility. Also, transformation from retained austenite to martensite occurs during blanking, increasing the generation of voids during hole expansion, which may reduce λ and lower bendability. Therefore, the C content is set to 0.030% or more and 0.500% or less. The C content is preferably 0.050% or more. The C content is more preferably 0.070% or more. The C content is preferably 0.400% or less. The C content is more preferably 0.300% or less.

### [Si: 0.01% or More and 2.50% or Less]

Si is one of the important basic components of steel, and particularly in the present disclosure, Si is an important element that affects the area ratio of martensite and ferrite. If the Si content is less than 0.01%, the area ratio of ferrite in the surface layer decreases, making it impossible to control the area ratio of martensite to be within the desired range in the region up to a depth of 10 μm from the surface of the base steel sheet. As a result, it becomes difficult to obtain high ultimate deformability, high local ductility, stretch flangeability, and bendability. On the other hand, if the Si content exceeds 2.50%, it suppresses carbide formation during continuous annealing and promotes the formation of retained austenite, which is a phase with high hydrogen solubility. Consequently, hydrogen desorption from the coated or plated steel sheet is not promoted, and the diffusible hydrogen content in the low temperature region of the base steel sheet increases, making it difficult to achieve the desired local ductility. Also, transformation from retained austenite to martensite occurs during blanking, increasing the generation of voids during hole expansion, which reduces 2. The bendability also decreases. Therefore, the Si content is set to 0.01% or more and 2.50% or less. The Si content is preferably 0.05% or more. The Si content is more preferably 0.10% or more. The Si content is preferably 2.00% or less. The Si content is more preferably 1.80% or less.

### [Mn: 0.10% or More and 5.00% or Less]

Mn is one of the important basic components of steel, and particularly in the present disclosure, Mn is an important element that affects the area ratio of martensite and ferrite. If the Mn content is less than 0.10%, the area ratio of martensite decreases, making it difficult to achieve the desired TS. On the other hand, if the Mn content exceeds 5.00%, the structure becomes predominantly quenched martensite, and since the diffusible hydrogen content in the low temperature region of the base steel sheet increases, it becomes difficult to achieve the desired local ductility, and A decreases, thereby also decreasing bendability. Therefore, the Mn content is set to 0.10% or more and 5.00% or less. The Mn content is preferably 0.80% or more. The Mn content is more preferably 1.00% or more. The Mn content is preferably 4.50% or less. The Mn content is more preferably 4.00% or less.

### [P: 0.100% or Less]

P is an element that segregates at the prior austenite grain boundary, embrittling the grain boundary and reducing the ultimate deformability of the steel sheet, and P potentially decreases the local ductility and λ as well. Therefore, the P content is 0.100% or less. The P content is preferably 0.070% or less. No lower limit is placed on the P content, but since P is a solid-solution-strengthening element that can increase the strength of the steel sheet, the P content is preferably 0.001% or more.

### [S: 0.0200% or Less]

S exists as a sulfide and is an element that reduces the ultimate deformability of the steel sheet, which may also degrade the local ductility and λ. Therefore, the S content is 0.0200% or less. The S content is preferably 0.0050% or less. No lower limit is placed on the S content, but due to production technology constraints, the S content is preferably 0.0001% or more.

### [Al: 1.000% or Less]

Al is an element that raises the A₃ transformation temperature, which can lead to a large amount of ferrite in the steel microstructure, making it difficult to achieve the desired TS. Therefore, the Al content is 1.000% or less. The Al content is preferably 0.100% or less. No lower limit is placed on the Al content, but the Al content is preferably 0.001% or more, since Al suppresses carbide formation during continuous annealing and promotes the formation of retained austenite.

### [N: 0.0100% or Less]

N exists as a nitride and is an element that reduces the ultimate deformability of the steel sheet, which may also degrade the local ductility and λ. Therefore, the N content is 0.0100% or less. The N content is preferably 0.0050% or less. No lower limit is placed on the N content, but due to production technology constraints, the N content is preferably 0.0001% or more.

### [O: 0.0100% or Less]

O exists as an oxide and is an element that reduces the ultimate deformability of the steel sheet, which may also degrade the local ductility and λ. Therefore, the O content is 0.0100% or less. The O content is preferably 0.0050% or less. No lower limit is placed on the O content, but due to production technology constraints, the O content is preferably 0.0001% or more.

### [Optional Components]

In addition to the above chemical composition, the base steel sheet of the present disclosure may further contain, in mass %, at least one element selected from the group consisting of
Ti: 0.200% or less, Nb: 0.200% or less, V: 0.200% or less,
Ta: 0.10% or less, W: 0.10% or less,
B: 0.0100% or less,
Cr: 1.00% or less, Mo: 1.00% or less, Ni: 1.00% or less,
Co: 0.010% or less,
Cu: 1.00% or less,
Sn: 0.200% or less,
Sb: 0.200% or less,
Ca: 0.0100% or less, Mg: 0.0100% or less, REM: 0.0100% or less,
Zr: 0.020% or less, Te: 0.020% or less,
Hf: 0.10% or less, and
Bi: 0.200% or less.

These elements may be included alone or in combinations of two or more.

When Ti, Nb, or V is contained, coarse precipitates and inclusions are generated in large quantities, which reduces the ultimate deformability of the steel sheet and decreases the local ductility and λ. To avoid this, the content of Ti, Nb, or V is preferably 0.200% or less. The content of Ti, Nb, or V is more preferably 0.100% or less. No lower limit is placed on the content of Ti, Nb, or V, but the content of Ti, Nb, or V is preferably 0.001% or more to increase the strength of the steel sheet by the formation of fine carbides, nitrides, or carbonitrides during hot rolling or continuous annealing.

When Ta or W is contained, coarse precipitates and inclusions are generated in large quantities, which reduces the ultimate deformability of the steel sheet and degrades the local ductility and λ. To avoid this, the content of Ta or W is preferably 0.10% or less. The content of Ta or W is more preferably 0.08% or less. No lower limit is placed on the content of Ta or W, but the content of Ta or W is more preferably 0.01% or more to increase the strength of the steel sheet by the formation of fine carbides, nitrides, or carbonitrides during hot rolling or continuous annealing.

When B is included, cracks are generated inside the steel sheet during casting or hot rolling, which reduces the ultimate deformability of the steel sheet and consequently degrades the local ductility and λ. To avoid this, the B content is preferably 0.0100% or less. The B content is more preferably 0.0080% or less. No lower limit is placed on the B content, but the B content is preferably 0.0003% or more, since B is an element that improves hardenability by segregating at austenite grain boundaries during annealing.

When Cr, Mo, or Ni is contained, coarse precipitates and inclusions increase, which reduces the ultimate deformability of the steel sheet and consequently degrades the local ductility and λ. To avoid this, the content of Cr, Mo, or Ni is preferably 1.00% or less. The content of Cr, Mo, or Ni is more preferably 0.80% or less. No lower limit is placed on the content of Cr, Mo, or Ni, but the content of Cr, Mo, or Ni is preferably 0.01% or more since these are elements that improve hardenability. When Co is contained, coarse precipitates and inclusions increase, which reduces the ultimate deformability of the steel sheet and consequently degrades the local ductility and λ. To avoid this, the Co content is preferably 0.010% or less. The Co content is more preferably 0.008% or less. No lower limit is placed on the Co content, but the Co content is preferably 0.001% or more, since Co is an element that improves hardenability. When Cu is contained, coarse precipitates and inclusions increase, which reduces the ultimate deformability of the steel sheet and consequently degrades the local ductility and λ. To avoid this, the Cu content is preferably 1.00% or less. The Cu content is more preferably 0.80% or less. No lower limit is placed on the Cu content, but the Cu content is preferably 0.01% or more since Cu is an element that improves hardenability.

When Sn is included, cracks are generated inside the steel sheet during casting or hot rolling, which reduces the ultimate deformability of the steel sheet and consequently degrades the local ductility and λ. To avoid this, the Sn content is preferably 0.200% or less. The Sn content is more preferably 0.100% or less. No lower limit is placed on the Sn content, but the Sn content is preferably 0.001% or more, since Sn is an element that improves hardenability.

When Sb is contained, coarse precipitates and inclusions increase, which reduces the ultimate deformability of the steel sheet and consequently degrades the local ductility and λ. To avoid this, the Sb content is preferably 0.200% or less. The Sb content is more preferably 0.100% or less. No lower limit is placed on the Sb content, but since Sb is an element that controls the area ratio of martensite in the region up to a depth of 10 μm from the surface of the base steel sheet and enables strength adjustment, the Sb content is preferably 0.001% or more.

When Ca, Mg, or REM is contained, coarse precipitates and inclusions increase, which reduces the ultimate deformability of the steel sheet and consequently degrades the local ductility and λ. To avoid this, the content of Ca, Mg, or REM is preferably 0.0100% or less. The content of Ca, Mg, or REM is more preferably 0.0050% or less. No lower limit is placed on the content of Ca, Mg, or REM, but the content of Ca, Mg, or REM is more preferably at least 0.0005%, since these elements make the shape of nitrides or sulfides spheroidal and improve the ultimate deformability of the steel sheet.

When Zr or Te is contained, coarse precipitates and inclusions increase, which reduces the ultimate deformability of the steel sheet and consequently degrades the local ductility and λ. To avoid this, the content of Zr or Te is preferably 0.100% or less. The content of Zr or Te is more preferably 0.080% or less. No lower limit is placed on the content of Zr or Te, but the content of Zr or Te is preferably at least 0.001%, since these elements make the shape of nitrides or sulfides spheroidal and improve the ultimate deformability of the steel sheet.

When Hf is contained, coarse precipitates and inclusions increase, which reduces the ultimate deformability of the steel sheet and consequently degrades the local ductility and λ. To avoid this, the Hf content is preferably 0.10% or less. The Hf content is more preferably 0.08% or less. No lower limit is placed on the Hf content, but the Hf content is preferably at least 0.01%, since Hf is an element that makes the shape of nitrides or sulfides spheroidal and improves the ultimate deformability of the steel sheet.

When Bi is contained, coarse precipitates and inclusions increase, which reduces the ultimate deformability of the steel sheet and consequently degrades the local ductility and λ. To avoid this, the Bi content is preferably 0.200% or less. The Bi content is more preferably 0.100% or less. No lower limit is placed on the Bi content, but the Bi content is preferably 0.001% or more, since Bi is an element that reduces segregation.

The base steel sheet of the present disclosure has a chemical composition containing essential components and optionally additional components, with the balance being Fe and inevitable impurities. Here, examples of the inevitable impurities include Zn, Pb, As, Ge, Sr, and Cs. Inclusion of these inevitable impurities is allowable in a total amount of 0.100% or less.

### [1-1-2] Steel Microstructure

The steel microstructure of the base steel sheet in the present disclosure will be described.

### [Area Ratio of Martensite at ¼ Thickness Position of the Base Steel Sheet: 30% or More]

If the area ratio of martensite at the ¼ thickness position of the base steel sheet is less than 30%, it becomes difficult to achieve the desired TS. Therefore, the area ratio of martensite is set to 30% or more. The area ratio of martensite at the ¼ thickness position of the base steel sheet is preferably 35% or more. The area ratio of martensite is more preferably 40% or more. The area ratio of martensite is even more preferably 45% or more. No upper limit is placed on the area ratio of martensite at the ¼ thickness position of the base steel sheet, but from the perspective of obtaining high ductility, the area ratio of martensite at the ¼ thickness position of the base steel sheet is preferably 95% or less. The area ratio of martensite is more preferably 90% or less. The area ratio of martensite is even more preferably 85% or less.

The martensite referred to here includes tempered martensite and bainite in addition to quenched martensite (fresh martensite).

### [Area Ratio of Ferrite at ¼ Thickness Position of the Base Steel Sheet: 70% or Less]

If the area ratio of ferrite at the ¼ thickness position of the base steel sheet is greater than 70%, it becomes difficult to achieve the desired TS. Therefore, the area ratio of ferrite at the thickness of ¼ of the base steel sheet is set to 70% or less. The area ratio of ferrite at the ¼ thickness position of the base steel sheet is preferably 65% or less. The area ratio of ferrite is more preferably 60% or less. The area ratio of ferrite is even more preferably 55% or less. No lower limit is placed on the area ratio of ferrite at the ¼ thickness position of the base steel sheet, but from the perspective of obtaining high ductility, the area ratio of ferrite at the ¼ thickness position of the base steel sheet is preferably 2% or more. The area ratio of ferrite is more preferably 5% or more. The area ratio of ferrite is even more preferably 10% or more.

The ferrite referred to here includes bainitic ferrite in addition to polygonal ferrite.

The method of measuring the area ratio of martensite (quenched martensite, tempered martensite, and bainite) at the ¼ thickness position of the base steel sheet and the area ratio of ferrite (polygonal ferrite and bainitic ferrite) at the ¼ thickness position of the base steel sheet is as follows.

A sample is cut from the steel sheet so that the sheet thickness cross-section (L cross-section) parallel to the rolling direction is the observation plane. Next, the observation plane of the sample is subjected to mirror polishing using diamond paste, then subjected to finishing polishing with alumina, and further etched with 3 volume % nital to reveal the microstructure.

Next, for the sample, the ¼ thickness position of the steel sheet is set as the observation plane, and under a set of conditions including an accelerating voltage of 10 kV, a scanning electron microscope (SEM) is used to observe at a 3000× magnification and obtain SEM images for three fields of view (1 field of view being 40 μm×30 μm).

From the obtained SEM images, the area ratio of each microstructure (ferrite (polygonal ferrite and bainitic ferrite), martensite (quenched martensite, tempered martensite, and bainite)) is calculated using Adobe Photoshop (produced by Adobe Systems). Specifically, the value obtained by dividing the area of each microstructure by the measured area is taken as the area ratio of each microstructure. The area ratio of each microstructure is calculated for three fields of view, and the average value of these area ratios is taken as the area ratio of each microstructure.

In the SEM images, ferrite (polygonal ferrite and bainitic ferrite) is a recessed microstructure that is flat and does not contain carbides, tempered martensite and bainite are recessed microstructures that contain fine carbides, and quenched martensite is a protruding structure with fine irregularities inside the microstructure, making these microstructures distinguishable from each other. Note that tempered martensite and bainite do not need to be distinguishable from each other, since the total area ratio is sought as the area ratio of martensite.

### [Area Ratio of Retained Austenite at the ¼ Thickness Position of the Base Steel Sheet: 10% or Less]

Since retained austenite is a phase with high hydrogen solubility, if the area ratio of retained austenite exceeds 10%, hydrogen desorption from the coated or plated steel sheet is not promoted, and the diffusible hydrogen content in the low temperature region of the base steel sheet increases, making it difficult to achieve the desired local ductility. Also, transformation from retained austenite to martensite occurs during blanking, increasing the generation of voids during hole expansion, which may reduce λ and lower bendability. The area ratio of the retained austenite at the ¼ thickness position of the base steel sheet is preferably as small as possible. The area ratio of the retained austenite is preferably 7% or less. The area ratio of the retained austenite is more preferably 5% or less. No lower limit is placed on the area ratio of retained austenite, and the desired properties can be obtained even with a volume fraction of 0% if the steel microstructure contains ferrite.

Here, the method of measuring the area ratio of retained austenite at the ¼ thickness position of the base steel sheet is as follows.

The steel sheet is ground so that the ¼ thickness position from the steel sheet surface (the position corresponding to ¼ of the thickness in the depth direction from the surface of the steel sheet) becomes the observation plane, and the steel sheet is further polished 0.1 mm through chemical polishing to obtain a sample.

For the measurement surface of the sample, an X-ray diffractometer is used to measure the integrated reflection intensities of the (200), (220), and (311) planes of fcc iron (austenite), along with the (200), (211), and (220) planes of bcc iron, using a Co Kα radiation source.

The intensity ratios of the integrated reflection intensities from each plane of fcc iron (austenite) to those from each plane of bcc iron are calculated. The average value of the nine intensity ratios is taken as the volume fraction of austenite from retained austenite. This volume fraction of austenite is then considered to be three-dimensionally uniform and is taken as the area ratio of retained austenite at the ¼ thickness position of the base steel sheet.

The steel microstructure at the ¼ thickness position of the base steel sheet contains at least one of ferrite and retained austenite. The total area ratio of ferrite and retained austenite is preferably 2% or more. The total area ratio is more preferably 5% or more. The total area ratio is even more preferably 10% or more.

### [Residual Microstructure]

The steel microstructure at the ¼ thickness position of the base steel sheet may have a microstructure (residual microstructure) other than martensite, ferrite, and retained austenite.

Known microstructures of steel sheets other than martensite, ferrite, and retained austenite can be mentioned as residual microstructures, and examples include pearlite, cementite, and carbides such as metastable carbides (epsilon (ε) carbide, eta (η) carbide, chi (χ) carbide, and the like). The identification of the residual microstructure can be performed by, for example, observation using SEM.

The area ratio of the residual microstructure at the ¼ thickness position of the steel sheet is preferably 5% or less and may be 0%.

The area ratio of the residual microstructure is calculated by the following formula.

$$[ area ratio of residual microstructure ( \% ) ] = 100 - [ area ratio of martensite ( \% ) ] - [ area ratio of ferrite ( \% ) ] - [ area ratio of retained austenite ( \% ) ]$$

[Area Ratio of Martensite in the Region Up to a Depth of 10 μm from the Surface of the Base Steel Sheet: 5% or More, and 80% or Less of the Area Ratio of Martensite at the ¼ Thickness Position of the Base Steel Sheet]

In the present disclosure, the area ratio of martensite at the surface layer of the base steel sheet is extremely important. By reducing the area ratio of martensite at the surface layer of the base steel sheet, in other words, by increasing the area ratio of phases with low hydrogen solubility such as ferrite, bainitic ferrite, and bainite at the surface layer of the base steel sheet, the desired bendability can be achieved. Moreover, increasing the area ratio of phases with low hydrogen solubility at the surface layer of the base steel sheet also contributes to the reduction of the diffusible hydrogen content in the low temperature region of the base steel sheet, which will be described later. To achieve such effects, the area ratio of martensite in the region up to a depth of 10 μm from the surface of the base steel sheet is set to 80% or less of the area ratio of martensite at the ¼ thickness position of the base steel sheet. The area ratio of martensite in the region up to a depth of 10 μm from the surface of the base steel sheet is preferably 75% or less of the area ratio of martensite at the ¼ thickness position of the base steel sheet. The area ratio of martensite in this region is more preferably 70% or less of the area ratio of martensite at the ¼ thickness position of the base steel sheet.

From the perspective of achieving the desired TS, the area ratio of martensite in the region up to a depth of 10 μm from the surface of the base steel sheet is 5% or more. The area ratio of martensite in this region is preferably 10% or more.

The martensite referred to here includes tempered martensite in addition to quenched martensite (fresh martensite).

Here, the area ratio of martensite in the region up to a depth of 10 μm from the surface of the base steel sheet is measured as follows.

A sample is cut from the base steel sheet so that the sheet thickness cross-section (L cross-section) parallel to the rolling direction is the observation plane. Next, the observation plane of the sample is polished. Next, the observation plane of the sample is etched with 3 volume % nital to reveal the microstructure.

Next, the region up to a depth of 10 μm from the surface of the base steel sheet is set as the observation position and observed with SEM at a magnification of 3000× over three fields of view (40 μm×10 μm, where 10 μm corresponds to the depth).

From the obtained microstructure images, the area of martensite is calculated for three fields of view using Adobe Photoshop from Adobe Systems. Next, the area of martensite calculated for each field of view is divided by the area of each field of view, and the arithmetic mean of those values is taken as the area ratio of martensite in the region up to a depth of 10 μm from the surface of the base steel sheet. In the above SEM images, martensite presents a white microstructure.

The area ratio of microstructures other than martensite in the region up to a depth of 10 μm from the surface of the base steel sheet is preferably 20% or more. This area ratio is more preferably 25% or more. This area ratio is even more preferably 30% or more. This area ratio is preferably 95% or less. This area ratio is more preferably 85% or less. This area ratio is even more preferably 70% or less.

The microstructures other than martensite in the region up to a depth of 10 μm from the surface of the base steel sheet are basically formed by ferrite (polygonal ferrite and bainitic ferrite).

The area ratio of ferrite in the region up to a depth of 10 μm from the surface of the base steel sheet is preferably 5% or more. This area ratio is more preferably 15% or more. This area ratio is even more preferably 30% or more. This area ratio is preferably 80% or less. This area ratio is more preferably 75% or less. This area ratio is preferably 70% or less. However, retained austenite may be included if its area ratio is 5% or less, though its area ratio may be 0%. Also, if the area ratio is 5% or less, other known microstructures of steel sheets, such as bainite, pearlite, cementite, or metastable carbides (epsilon (ε) carbide, eta (η) carbide, chi (χ) carbide, or the like) may be included. Identification of the microstructure can be performed, for example, by observation using an SEM (Scanning Electron Microscope).

The area ratio of microstructures other than martensite is calculated by the following formula.

$$[ area ratio ( \% ) ] = 100 - [ area ratio of martensite ( \% ) ]$$

### [1-1-3] Diffusible Hydrogen Content in the Low Temperature Region of Base Steel Sheet

The diffusible hydrogen content in the low temperature region of the base steel sheet is an extremely important constituent element of the present disclosure. In other words, we have diligently studied how to obtain a hot-dip galvanized steel sheet, with a TS of 980 MPa or more, that has high ductility, high stretch flangeability, and bendability, along with high local ductility, and found that the diffusible hydrogen content in the low temperature region of the base steel sheet, i.e., the amount of hydrogen released from the base steel sheet when the base steel sheet is heated from room temperature to 50° C., greatly affects the above characteristics, especially the local ductility. According to our findings, the local ductility depends more on the amount of hydrogen released in the low temperature region, specifically in the temperature range from room temperature to 50° C. (diffusible hydrogen content in the low temperature region), than on the amount of hydrogen released from the base steel sheet at high temperatures when the base steel sheet is heated. It is thus difficult to achieve high local ductility while having high ductility, high stretch flangeability, and bendability when the diffusible hydrogen content in the low temperature region exceeds 0.015 mass ppm. Therefore, the diffusible hydrogen content in the low temperature region of the base steel sheet is set to 0.015 mass ppm or less. The lower the diffusible hydrogen content in the low temperature region of the base steel sheet, the better. The diffusible hydrogen content is preferably 0.010 mass ppm or less. The diffusible hydrogen content is more preferably 0.006 mass ppm or less. The diffusible hydrogen content may be 0 ppm.

Here, the method of measuring the diffusible hydrogen content in the low temperature region of the base steel sheet is as follows.

A test piece with a length of 30 mm and a width of 5 mm is collected from the sample central position of the hot-dip galvanized steel sheet by shearing. Immediately after collection, the test piece is immersed in liquid nitrogen. While managing the temperature of the treatment solution so that the surface temperature of the test piece is 10° C. or less, the hot-dip galvanized layer of the test piece is removed with alkali. Next, the test piece is loaded into a thermal desorption spectrometry apparatus, and after waiting for 5 minutes with Ar gas flowing, heating is started. Specifically, the test piece is heated under a set of conditions including a heating end-point temperature of 300° C. and a heating rate of 200° C./hr, and is then cooled to room temperature for measurement. The surface temperature of the test piece at the start of heating is set to 10° C. or less.

The obtained amount of hydrogen released from the test piece in the temperature range from the temperature at the start of heating (room temperature) to 50° C. (hereinafter also referred to as the cumulative released hydrogen amount) is measured, and the diffusible hydrogen content in the low temperature region of the base steel sheet is calculated using the following expression.

$$[ diffusible hydrogen content in low temperature region of base steel sheet ( mass ppm ) ] = [ cumulative released hydrogen amount ( g ) ] \div [ mass of test piece ( g ) ] \times {10}^{6}$$

For hot-dip galvanized steel sheets subjected to processing such as punching, stretch flange forming, and bending, as well as products (members) produced by welding the processed steel sheets, the diffusible hydrogen content in the low temperature region of the base steel sheet portion can be measured in the same manner as above.

### [1-1-4] Sheet Thickness

No limit is placed on the thickness of the base steel sheet, and the thickness can be set according to the thickness of the final hot-dip galvanized steel sheet. The thickness can, for example, be 0.3 mm or more and 3.0 mm or less.

### [1-1-5] Surface Soft Layer

The surface layer of the base steel sheet is preferably a soft layer (surface soft layer). Since the surface soft layer contributes to suppressing the propagation of bending cracks during press forming and automotive body collisions, the bending fracture resistance characteristics can be further improved.

The surface layer refers to the region corresponding to a thickness of 200 μm up to 200 μm in the thickness direction from the surface of the base steel sheet.

The soft layer refers to the region with a Vickers hardness of 85% or less compared to the Vickers hardness of a cross-section (a plane parallel to the steel sheet surface) at the ¼ thickness position of the base steel sheet. The soft layer includes the decarburized layer at the surface layer of the base steel sheet.

The surface soft layer refers to the soft layer contained in the surface layer and can be the entire surface layer or part of the surface layer. The surface soft layer can correspond to a region with a thickness of up to 200 μm in the thickness direction from the surface of the base steel sheet.

For example, if the region with 85% or less hardness compared to the Vickers hardness of a cross-section (a plane parallel to the steel sheet surface) at the ¼ thickness position of the base steel sheet is formed at a predetermined depth in the thickness direction from the surface of the base steel sheet, and the predetermined depth is within 200 μm in the thickness direction, then the region corresponding to the thickness from the surface to the predetermined depth is the surface soft layer. If the predetermined depth exceeds 200 μm in the thickness direction, the region corresponding to a thickness of 200 μm from the surface of the base steel sheet up to 200 μm in the thickness direction is the surface soft layer.

In the case of including a surface soft layer, no lower limit is placed on the thickness of the surface soft layer, but the thickness is preferably 8 μm or more. The thickness is more preferably over 17 μm.

The Vickers hardness is measured based on JIS Z 2244-1 (2020) with a load of 10 gf.

In the case of including a surface soft layer, when the nanohardness is measured at 300 or more points in a 50 μm×50 μm region of the sheet surface at a ¼ depth position in the thickness direction of the surface soft layer from the surface of the base steel sheet (a position at ¼ of the thickness of the surface soft layer in the depth direction from the surface of the base steel sheet), the ratio of points having a nanohardness of 7.0 GPa or more is preferably 0.10 or less. If the ratio of points with a nanohardness of 7.0 GPa or more is 0.10 or less, the proportion of hard microstructures (such as martensite), inclusions, and the like is small, which can further suppress the generation and connection of voids, and also the progression of cracks, during press forming and collision in hard structures (such as martensite), inclusions, and the like, making it easier to obtain excellent bendability during press forming and excellent bending fracture characteristics during collision.

In the present disclosure, to obtain excellent bendability during press forming and excellent bending fracture characteristics during collision, it is preferable that the standard deviation σ of the nanohardness of the sheet surface at the ¼ depth position in the thickness direction of the surface soft layer depth from the surface of the base steel sheet be 1.8 GPa or less, and furthermore that the standard deviation σ of the nanohardness of the sheet surface at the ½ depth position in the thickness direction of the surface soft layer depth from the surface of the base steel sheet be 2.2 GPa or less. When the standard deviation σ of the nanohardness of the sheet surface at the ¼ depth position in the thickness direction of the surface soft layer from the surface of the base steel sheet is 1.8 GPa or less, and furthermore, the standard deviation σ of the nanohardness of the sheet surface at the ½ depth position in the thickness direction of the surface soft layer from the surface of the base steel sheet is 2.2 GPa or less, the hardness difference in the micro region is small, which can further suppress the generation and connection of voids, and also the progression of cracks, during press forming and collision, making it easier to obtain excellent bendability and excellent bending fracture characteristics during collision.

A more preferable range for the standard deviation σ of the nanohardness of the sheet surface at the ¼ depth position in the thickness direction of the surface soft layer from the surface of the base steel sheet is 1.7 GPa or less. A more preferable range for the standard deviation σ of the nanohardness of the sheet surface at the ½ depth position in the thickness direction of the surface soft layer from the surface of the base steel sheet is 2.1 GPa or less.

Here, the nanohardness of the sheet surface at the ¼ and ½ depth positions in the thickness direction is the hardness measured by the following method.

First, if a coated or plated layer is formed, after peeling the coated or plated layer off, mechanical polishing is performed up to the ¼ depth position in the thickness direction of the surface soft layer from the surface of the base steel sheet, followed by buff polishing with diamond and alumina, and then colloidal silica polishing. The nanohardness is measured under a set of conditions including a load of 500 μN, a measurement region of 50 μm×50 μm, and a point interval of 2 μm using a Berkovich diamond indenter.

In addition, mechanical polishing is performed up to the ½ depth position in the thickness direction of the surface soft layer, followed by buff polishing with diamond and alumina, and then colloidal silica polishing. The nanohardness is then measured under a set of conditions including a load of 500 μN, a measurement region of 50 μm×50 μm, and a point interval of 2 μm using a Berkovich diamond indenter.

Here, the thickness of the surface soft layer can be measured by the following method. After smoothing a thickness cross-section (L cross-section) of the base steel sheet parallel to the rolling direction by wet polishing, measurements were taken using a Vickers hardness tester at a load of 10 gf, from a position of 1 μm in the thickness direction from the surface of the base steel sheet to a position of 100 μm in the thickness direction, at intervals of 1 μm. Subsequently, measurements were taken at intervals of 20 μm up to the mid-thickness. The region where the hardness decreases to 85% or less compared to the hardness at the ¼ thickness position is defined as the soft layer (surface soft layer), and the thickness of that region in the thickness direction is taken as the thickness of the soft layer.

### [1-2] Metal Coated or Plated Layer

The base steel sheet preferably has a metal coated or plated layer on one side or both sides. Since the metal coated or plated layer contributes to suppressing the occurrence of bending cracks during press forming and automotive body collisions, the bending fracture resistance characteristics can be further improved.

The coated or plated layer is directly formed on the surface of the base steel sheet and is a metal coated or plated layer containing a total of over 50 mass % of one or more selected from Al, Cr, Mn, Fe, Co, Ni, Cu, Ga, Ge, As, Ru, Rh, Pd, Ag, Cd, In, Sn, Sb, Os, Ir, Rt, Au, Hg, Ti, Pb, and Bi, excluding a galvanized layer, i.e., a hot-dip galvanized layer, a galvannealed layer, and an electrogalvanized layer. The first coated or plated layer is preferably a metal electroplating layer and is described below using a metal electroplating layer as an example.

By formation of a metal electroplating layer on the surface of the steel sheet, the metal electroplating layer that becomes the outermost layer contributes to suppressing bending cracks during press forming and automotive body collision, thereby further improving the bending fracture resistance characteristics.

As for the metal species of the metal electroplating layer, any of Al, Cr, Mn, Fe, Co, Ni, Cu, Ga, Ge, As, Ru, Rh, Pd, Ag, Cd, In, Sn, Sb, Os, Ir, Rt, Au, Hg, Ti, Pb, and Bi is acceptable, but Fe is more preferable. An Fe-based electroplating layer is described below as an example.

The coating weight of the Fe-based electroplating layer is set to be more than 0 g/m². The coating weight is preferably 2.0 g/m² or more. No upper limit is placed on the coating weight per side of the Fe-based electroplating layer, but from a cost perspective, the coating weight per side of the Fe-based electroplating layer is preferably set to be 60 g/m² or less. The coating weight of the Fe-based electroplating layer is preferably 50 g/m² or less. The coating weight is more preferably 40 g/m² or less. The coating weight is even more preferably 30 g/m² or less.

The coating weight of the Fe-based electroplating layer is measured as follows. A sample with a size of 10 mm×15 mm is taken from the Fe-based electroplated steel sheet and embedded in resin to create a cross-sectional embedded sample. Using a scanning electron microscope (SEM) at an accelerating voltage of 15 kV, the thickness of the Fe-based coated or plated layer is observed at a magnification of 2000 to 10000 times at any three locations of the same cross-section, and the average thickness of the three fields of view is multiplied by the density of iron for conversion to the coating weight per side of the Fe-based coated or plated layer.

As the Fe-based electroplating layer, an alloy coated or plated layer such as Fe—B alloy, Fe—C alloy, Fe—P alloy, Fe—N alloy, Fe—O alloy, Fe—Ni alloy, Fe—Mn alloy, Fe—Mo alloy, and Fe—W alloy can be used in addition to pure Fe. The chemical composition of the Fe-based electroplating layer is not particularly limited, but the chemical composition preferably contains one or more elements selected from the group consisting of B, C, P, N, O, Ni, Mn, Mo, Zn, W, Pb, Sn, Cr, V, and Co at a total of 10 mass % or less, with the balance being Fe and inevitable impurities. By limiting the total amount of elements other than Fe to 10 mass % or less, a decrease in electrolysis efficiency can be prevented, and an Fe-based electroplating layer can be formed at low cost. In the case of Fe—C alloys, the C content is preferably 0.08 mass % or less.

The base steel sheet for hot-dip galvanizing may be either a base steel sheet alone or a base steel sheet with a metal coated or plated layer. The base steel sheet for hot-dip galvanizing is preferably a base steel sheet on which a metal coated or plated layer is formed on the surface of a base steel sheet having a surface soft layer.

### [1-3] Hot-Dip Galvanized Layer

The hot-dip galvanized layer in the hot-dip galvanized steel sheet is described. The hot-dip galvanized layer referred to here also includes a galvannealed layer (a coating layer obtained by subjecting hot-dip galvanizing to alloying treatment). The hot-dip galvanized layer can be provided on both sides of the surface of the base steel sheet, and in that case, the hot-dip galvanized layer may be directly formed on the surface of the base steel sheet, or if the surface of the base steel sheet includes a surface soft layer, a metal electroplating layer, or the like, the hot-dip galvanized layer may be formed on those layers.

The hot-dip galvanized layer typically has Zn (zinc) as the main component (with a Zn content of 50.0 mass % or more). The composition is not particularly limited and can be a known composition. The hot-dip galvanized layer is preferably formed by Zn, 20.0 mass % or less of Fe, and 0.001 mass % or more and 1.0 mass % or less of Al, for example. In addition, the hot-dip galvanized layer may optionally contain one or more elements selected from the group consisting of Pb, Sb, Si, Sn, Mg, Mn, Ni, Cr, Co, Ca, Cu, Li, Ti, Be, Bi, and REM in a total of more than 0.0 mass % and 3.5 mass % or less. The Fe content in the hot-dip galvanized layer is preferably less than 7.0 mass %. The balance other than the aforementioned elements is inevitable impurities.

The galvannealed layer is preferably formed by 20.0 mass % or less of Fe and 0.001 mass % or more and 1.0 mass % or less of Al, for example. In addition, the galvannealed layer may optionally contain one or more elements selected from the group consisting of Pb, Sb, Si, Sn, Mg, Mn, Ni, Cr, Co, Ca, Cu, Li, Ti, Be, Bi, and REM in a total of more than 0 mass % and 3.5 mass % or less. The Fe content in the galvannealed layer is preferably 7.0 mass % or more. The Fe content is more preferably 8.0 mass % or more. The Fe content in the galvannealed layer is preferably 15.0 mass % or less. The Fe content is more preferably 12.0 mass % or less. The balance other than the aforementioned elements is inevitable impurities.

No limit is placed on the coating weight per side of the hot-dip galvanized layer. For example, the coating weight can be 20 g/m² or more and 80 g/m² or less.

The coating weight of the aforementioned galvanized layer is measured as follows. A treatment solution is prepared by adding 0.6 g of a corrosion inhibitor for Fe (Asahi Chemical Co., Ltd. “IBIT 700 BK”® (IBIT 700 BK is a registered trademark in Japan, other countries, or both)) to 1L of a 10 mass % hydrochloric acid aqueous solution. Next, a sample of a steel sheet provided with a galvanized layer is immersed in the treatment solution to dissolve the galvanized layer. Then, the coating weight (g/m²) is calculated by measuring the mass reduction of the sample from before to after dissolving and dividing that value by the surface area of the base steel sheet (the surface area of the part covered by the coating).

The hot-dip galvanized layer preferably has cracks. By intentionally introducing cracks into the hot-dip galvanized layer, it is possible to further reduce the diffusible hydrogen content in the low temperature region of the base steel sheet.

Here, the presence or absence of cracks in the hot-dip galvanized layer is determined as follows. The surface (front and back) of the hot-dip galvanized layer of the hot-dip galvanized steel sheet is observed using an SEM at a magnification of 3000× over two fields of view per surface (1 field of view: 30 μm×40 μm), for a total of four fields of view. If one or more cracks penetrating the hot-dip galvanizing are present in any of the four fields of view, cracks are determined to be present. If there are no cracks penetrating the hot-dip galvanizing in any of the four fields of view, cracks are determined to be absent.

### [1-4] Other

No limit is placed on the thickness of the hot-dip galvanized steel sheet of the present disclosure, but the thickness is usually 0.3 mm or more and 2.8 mm or less.

The TS of the hot-dip galvanized steel sheet of the present disclosure is 980 MPa or more. The method of measuring TS complies with JIS Z 2241, as described in the EXAMPLES section below.

The hot-dip galvanized steel sheet of the present disclosure can have an ultimate deformability of 0.10 or more. The local ductility and stretch flangeability of the hot-dip galvanized steel sheet greatly depend on the ultimate deformability of the annealed sheet after cold rolling, and making the ultimate deformability of the hot-dip galvanized steel sheet 0.10 or more is effective in providing high ductility, high stretch flangeability, and bendability while having high local ductility. The higher the ultimate deformability, the more preferable. The ultimate deformability is preferably 0.30 or more. The ultimate deformability is more preferably 0.50 or more. No upper limit is established, but the ultimate deformability is usually 2.10 or less.

Here, the ultimate deformability (ε₁) is calculated by the method described in “Mizuno et al.: Reports of the Institute of Physical and Chemical Research, 45-4 (1969), 79”. Specifically, the limit deformability (ε₁) is calculated using the following expressions.

$${ε}_{w} = ln ( W / {W}_{0} )$$

$${ε}_{t} = ln ( T / {T}_{0} )$$

$${ε}_{l} = - ( {ε}_{w} + {ε}_{t} )$$

In the expressions, W₀ represents the initial sheet width, W represents the width of the fractured part, T represents the initial sheet thickness, and T₀ represents the thickness of the fractured part. The width and thickness of the fractured part are measured according to the method specified in JIS Z 2241, as described in the EXAMPLES section below.

### [2] Method of Producing Hot-Dip Galvanized Steel Sheet

A method of producing the hot-dip galvanized steel sheet of the present disclosure is now described. The method, according to the present disclosure, of producing a hot-dip galvanized steel sheet is also a method of producing the above-described hot-dip galvanized steel sheet of the present disclosure.

The method, according to the present disclosure, of producing a hot-dip galvanized steel sheet of the present disclosure includes
subjecting a steel slab having the aforementioned chemical composition to
hot rolling under a set of conditions including a coiling temperature of 400° C. or more and 700° C. or less to obtain a hot-rolled steel sheet;
subsequently subjecting the hot-rolled steel sheet to pickling;
subsequently subjecting the hot-rolled steel sheet to cold rolling under a set of conditions including a cumulative rolling reduction ratio of 30% or more and a unit tension of 10 kgf/mm² or more between a final pass and a pass immediately before the final pass to obtain a cold-rolled steel sheet;
subsequently heating the cold-rolled steel sheet to an annealing temperature T₁ of 750° C. or more and 950° C. or less with an oxygen concentration of 0.5 vol % or more and 5.0 vol % or less in a temperature range of 250° C. or more and 700° C. or less;
annealing the cold-rolled steel sheet under a set of conditions including setting a dew point to −30° C. or more in a temperature range above 700° C. and T₁ or less, and retaining the cold-rolled steel sheet for a retention time of 10 s or more and 500 s or less in the temperature range;
subsequently subjecting the cold-rolled steel sheet subjected to the annealing to hot-dip galvanizing treatment to obtain a coated steel sheet; and
subsequently cooling the coated steel sheet to obtain a hot-dip galvanized steel sheet.

The above temperatures, unless otherwise specified, are based on the surface temperature of the steel slab or steel sheet.

### [2-1] Hot Rolling

The steel slab (slab) is subjected to hot rolling to produce a hot-rolled steel sheet. The method of melting the steel slab is not particularly limited, and any known melting method such as a converter or electric furnace is suitable. The steel slab is preferably made with continuous casting to prevent macro segregation but may be produced with other methods such as ingot casting or thin slab casting.

After producing the steel slab, in addition to the conventional method of cooling to room temperature and then reheating, energy-saving processes such as hot charge rolling and hot direct rolling can also be applied without any issues. Hot charge rolling is a process in which the slab is charged into the heating furnace without cooling to room temperature, while still in the warm slab state. Hot direct rolling is a process in which rolling is performed immediately after slight holding.

When heating the steel slab, from the perspective of carbide dissolution and reduction of rolling load, it is preferable to set the slab heating temperature to 1100° C. or more. In addition, to prevent an increase in scale loss, it is preferable to set the slab heating temperature to 1300° C. or lower.

Here, the slab heating temperature refers to the temperature of the slab surface.

Next, the slab is hot rolled. Hot rolling can consist of rough rolling and finish rolling.

For example, the slab can be made into a sheet bar by rough rolling. The conditions for rough rolling are not particularly limited and can be known conditions.

Next, the sheet bar can be subjected to finish rolling. If the slab heating temperature is set lower, it is preferable to heat the sheet bar using a bar heater or the like before finish rolling to prevent trouble during rolling.

The rolling finish temperature is preferably equal to or greater than the Ar₃ transformation temperature. If the rolling finish temperature is equal to or greater than the Ar₃ transformation temperature, an increase in rolling load and an increase in rolling reduction in the non-recrystallized state of austenite can be avoided, thereby suppressing the development of an abnormal microstructure elongated in the rolling direction and easily avoiding a decrease in workability of the steel sheet obtained after annealing.

The Ar₃ transformation temperature is determined by the following expression.

$${Ar}_{3} ( ° C . ) = 868 - 3 \; 96 \times [ \% C ] + 24.6 \times [ \% Si ] - 68.1 \times [ \% Mn ] - 36.1 \times [ \% Ni ] - 20.7 \times [ \% Cu ] - 24.8 \times [ \% Cr ]$$

In the above expression, [% element symbol] represents the content (mass %) of the corresponding element in the chemical composition.

Finish rolling may be conducted continuously by joining the sheet bars together. Also, the sheet bar may be temporarily coiled before finish rolling. Furthermore, to reduce the rolling load, part or all of the finish rolling may be conducted as lubrication rolling. Conducting lubrication rolling in such a manner is effective in terms of making shape and material property of a steel sheet uniform. In lubrication rolling, the frictional coefficient is preferably 0.10 or more. The frictional coefficient is preferably 0.25 or less.

### [Coiling Temperature: 400° C. Or More and 700° C. Or Less]

In the manufacturing method of the present disclosure, control of the coiling temperature in the hot rolling is particularly important.

In the hot rolling, after finish rolling, the hot-rolled sheet is coiled and recovered, and then cooled. By setting the coiling temperature to 400° C. or more, carbon diffuses into the oxide scale generated during rolling, which promotes decarburization of the surface layer of the hot-rolled steel sheet, making it possible to control the area ratio of martensite, in the region up to a depth of 10 μm from the surface of the base steel sheet, to be within the desired range. As the area ratio of martensite in the region up to a depth of 10 μm from the surface of the base steel sheet decreases, the diffusible hydrogen content in the low temperature region of the base steel sheet also decreases. As a result, it becomes possible to obtain high ultimate deformability, high local ductility, stretch flangeability, and bending ability. However, if the coiling temperature exceeds 700° C., the area ratio of martensite in the region up to a depth of 10 μm from the surface of the base steel sheet decreases, making it difficult to achieve the desired TS. Therefore, the coiling temperature is set to 400° C. or more and 700° C. or less. The coiling temperature is preferably 430° C. or more. The coiling temperature is more preferably 450° C. or more. The coiling temperature is preferably 670° C. or less. The coiling temperature is more preferably 650° C. or less.

The cooling conditions after coiling are not particularly limited, and known conditions can be adopted. For example, the cooling rate is preferably 0.001° C./s or more and 1° C./s or less. The cooling stop temperature is preferably 20° C. or more and 200° C. or less.

### [2-2] Pickling

After the hot-rolling, the hot-rolled steel sheet is pickled. Pickling can remove oxides from the surface of the steel sheet, ensuring good chemical convertibility and coating or plating quality. Pickling may be performed only once or may be performed in multiple stages. The pickling conditions are not particularly limited, and known conditions can be applied.

### [2-3] Heat Treatment (Optional)

After pickling, the hot-rolled steel sheet may be subjected to heat treatment (hot-rolled sheet annealing). The heat treatment conditions are not particularly limited. Examples include the following conditions.

### [Heat Treatment Temperature: 450° C. Or More and 650° C. Or Less (Preferred Condition)]

By applying heat treatment to the hot-rolled steel sheet, decarburization of the surface layer of the hot-rolled steel sheet is promoted, making it possible to control the area ratio of martensite, in the region up to a depth of 10 μm from the surface of the base steel sheet, to be within a more preferred range. The heat treatment temperature is therefore preferably 450° C. or more. On the other hand, if the heat treatment temperature exceeds 650° C., the area ratio of martensite in the region up to a depth of 10 μm from the surface of the base steel sheet decreases, and TS decreases. Therefore, the heat treatment temperature is preferably 450° C. or more. The heat treatment temperature is preferably 650° C. or less. The heat treatment temperature is more preferably 460° C. or more. The heat treatment temperature is even more preferably 470° C. or more. The heat treatment temperature is more preferably 600° C. or less. The heat treatment temperature is even more preferably 550° C. or less.

[Retention time in the temperature range of 400° C. or more and heat treatment temperature or less (hereinafter also referred to as retention time in the heat treatment temperature range): 10 minutes or more (preferred condition)]

By setting the retention time in the temperature range of 400° C. or more and the heat treatment temperature or less (hereinafter also referred to as “retention time in the heat treatment temperature range”) to 10 minutes or more, decarburization of the surface layer of the hot-rolled steel sheet is promoted, making it possible to control the area ratio of martensite, in the region up to a depth of 10 μm from the surface of the base steel sheet, to be within a more preferred range. Therefore, the retention time in the heat treatment temperature range is preferably 10 minutes or more. The retention time is more preferably 100 minutes or more. The retention time is even more preferably 500 minutes or more. No upper limit is placed on the retention time in the heat treatment temperature range, but from the perspective of controlling the area ratio of martensite in the region up to a depth of 10 μm from the surface of the base steel sheet to be within a more preferred range, the retention time is preferably 3000 minutes or less. The retention time is more preferably 2000 minutes or less.

### [2-4] Cold Rolling

Next, the hot-rolled steel sheet is subjected to cold rolling to yield a cold-rolled steel sheet. In the production method of the present disclosure, it is important to satisfy the following set of conditions at that time.

### [Cumulative Rolling Reduction Ratio in Cold Rolling: 30% or More]

By increasing the cumulative rolling reduction ratio of cold rolling, decarburization of the surface layer is promoted during annealing, and it becomes possible to control the area ratio of martensite in the region up to a depth of 10 μm from the surface of the base steel sheet to be within the desired range. As the area ratio of martensite in the region up to a depth of 10 μm from the surface of the base steel sheet decreases, the diffusible hydrogen content in the low temperature region of the base steel sheet also decreases. As a result, it becomes possible to obtain high ultimate deformability, high local ductility, stretch flangeability, and bending ability. Therefore, the cumulative rolling reduction ratio of cold rolling is set to 30% or more. The cumulative rolling reduction ratio of cold rolling is preferably 35% or more. The cumulative rolling reduction ratio of cold rolling is more preferably 40% or more. No upper limit is placed on the cumulative rolling reduction ratio of cold rolling, but due to production technology constraints, the cumulative rolling reduction ratio of cold rolling is preferably 90% or less. The cumulative rolling reduction ratio of cold rolling is more preferably 85% or less.

### [Unit Tension Between the Final Pass of Cold Rolling and the Pass Immediately Before the Final Pass: 10 Kgf/Mm² or More]

By increasing the tension in the unit between the final pass of cold rolling and the pass immediately before the final pass, it is possible to introduce strain into the surface layer of the steel sheet during cold rolling. This promotes decarburization of the surface layer during annealing, allowing for control of the area ratio of martensite in the region up to a depth of 10 μm from the surface of the base steel sheet to be within the desired range. As the area ratio of martensite in the region up to a depth of 10 μm from the surface of the base steel sheet decreases, the diffusible hydrogen content in the low temperature region of the base steel sheet also decreases. As a result, it becomes possible to obtain high ultimate deformability, high local ductility, stretch flangeability, and bending ability. From this perspective, the unit tension between the final pass of cold rolling and the pass immediately before the final pass is set to 10 kgf/mm² or more. This unit tension is preferably 15 kgf/mm² or more. No upper limit is placed on the unit tension between the final pass of cold rolling and the pass immediately before the final pass, but due to production technology constraints, the unit tension is preferably 100 kgf/mm² or less. The unit tension is more preferably 50 kgf/mm² or less.

Other cold rolling conditions are not particularly limited, and known conditions can be adopted. For example, cold rolling can be performed using tandem multi-stand rolling, reverse rolling, or the like. The number of rolling passes and the reduction ratio for each pass are not particularly limited, and known conditions can be adopted.

### [2-5] Metal Coating or Plating (Optional)

A metal coating or plating treatment can be applied to the surface of the cold-rolled steel sheet obtained as described above, resulting in a pre-annealing metal coated or plated steel sheet having a metal coated or plated layer (pre-annealing metal coated or plated layer) formed on at least one side thereof. The pre-annealing metal coated or plated steel sheet is preferably a pre-annealing metal electroplated steel sheet having a pre-annealing metal electroplating layer.

The method of metal electroplating is not particularly limited, but as described above, metal electroplating treatment is preferably applied, since the metal coated or plated layer to be formed on the base steel sheet is preferably a metal electroplating layer. For example, a sulfuric acid bath, a hydrochloric acid bath, or a mixture of both can be applied in an Fe-based electroplating bath. Moreover, the coating weight of the pre-annealing metal electroplating layer can be adjusted by the current passage time and the like. Here, the pre-annealing metal electroplated steel sheet refers to the metal electroplating layer not having undergone the annealing and does not exclude hot-rolled steel sheets, post-hot rolling acid-pickled sheets, or cold-rolled steel sheets that were annealed in advance before the metal electroplating treatment.

Here, the metal species of the electroplating layer can be any of Al, Cr, Mn, Fe, Co, Ni, Cu, Ga, Ge, As, Ru, Rh, Pd, Ag, Cd, In, Sn, Sb, Os, Ir, Rt, Au, Hg, Ti, Pb, and Bi, but Fe is more preferable. A method of producing Fe-based electroplating is therefore described below.

The Fe ion concentration in the Fe-based electroplating bath before the start of current passage is preferably 0.5 mol/L or more as Fe²⁺. If the Fe ion concentration in the Fe-based electroplating bath is 0.5 mol/L or more as Fe²⁺, a sufficient Fe coating weight can be obtained. To obtain a sufficient Fe coating weight, the Fe ion concentration in the Fe-based electroplating bath before the start of current passage is preferably 2.0 mol/L or less.

The Fe-based electroplating bath can contain at least one element selected from the group consisting of B, C, P, N, O, Ni, Mn, Mo, Zn, W, Pb, Sn, Cr, V, and Co, in addition to Fe ions. The total content of these elements in the Fe-based electroplating bath is preferably adjusted so that the total content of these elements in the Fe-based electroplating layer before annealing is 10 mass % or less. Metal elements may be contained as metal ions, while non-metal elements can be included as part of boric acid, phosphoric acid, nitric acid, organic acids, or the like. The sulfuric acid iron plating solution may also contain a conductivity aid such as sodium sulfate or potassium sulfate, a chelating agent, and a pH buffer.

Other conditions of the Fe-based electroplating bath are not particularly limited. The temperature of the Fe-based electroplating solution is preferably set to 30° C. or more from the perspective of constant temperature retention. The temperature is preferably 85° C. or less. The pH of the Fe-based electroplating bath is not particularly limited, but the pH is preferably 1.0 or more to prevent a decrease in current efficiency due to hydrogen generation. The pH is also preferably 3.0 or less from the perspective of electrical conductivity of the Fe-based electroplating bath. The current density is preferably set to 10 A/dm² or more from the perspective of productivity. The current density is preferably 150 A/dm² or less to facilitate control of the coating weight of the Fe-based electroplating layer. The sheet passing speed is preferably set to 5 mpm or more from the perspective of productivity. The sheet passing speed is also preferably 150 mpm or less to stably control the coating weight.

As pretreatment before applying the Fe-based electroplating treatment, degreasing treatment and water washing to clean the surface of the cold-rolled steel sheet, as well as pickling treatment and water washing to activate the surface of the cold-rolled steel sheet, can be performed. Following these pretreatments, the Fe-based electroplating treatment is carried out. The methods for degreasing treatment and water washing are not particularly limited, and conventional methods may be used.

In the pickling treatment, various acids such as sulfuric acid, hydrochloric acid, nitric acid, and mixtures thereof can be used. Among these, sulfuric acid, hydrochloric acid, and mixtures thereof are preferred. The concentration of the acid is not particularly limited, but from the perspective of the ability to remove oxide coatings and prevent skin roughness (surface defects) due to over-pickling, the concentration is preferably 1 mass % or more. The concentration is preferably 20 mass % or less.

The pickling treatment solution may also contain a defoamer, a pickling accelerator, a pickling inhibitor, and the like.

### [2-6] Annealing

The cold-rolled steel sheet obtained as described above is subjected to annealing. At this time, it is important to satisfy the following set of conditions. That is, the cold-rolled steel sheet is heated to the annealing temperature Ti of 750° C. or more and 900° C. or less with the oxygen concentration in the temperature range of 250° C. or more and 700° C. or less set to 0.5 vol % or more and 5.0 vol % or less, the dew point is set to −30° C. or more in a temperature range above 700° C. and Ti or less, and the cold-rolled steel sheet is retained for a retention time of 10 s or more and 500 s or less in this temperature range.

### [Oxygen Concentration in the Temperature Range of 250° C. Or More and 700° C. Or Less: 0.5 Vol % or More and 5.0 Vol % or Less]

By increasing the oxygen concentration in the heating temperature range, decarburization progresses through the oxygen in the atmosphere, making it possible to control the area ratio of martensite, in the region up to a depth of 10 μm from the surface of the base steel sheet, to be within the desired range. As the area ratio of martensite in the region up to a depth of 10 μm from the surface of the base steel sheet decreases, the diffusible hydrogen content in the low temperature region of the base steel sheet also decreases. As a result, it becomes possible to obtain high ultimate deformability, high local ductility, stretch flangeability, and bending ability. To achieve such an effect, the oxygen concentration in the heating temperature range is set to 0.5 vol % or more. On the other hand, if the oxygen concentration in the heating temperature range exceeds 5.0 vol %, the area ratio of martensite in the region up to a depth of 10 μm from the surface of the base steel sheet decreases, making it difficult to achieve the desired TS. Therefore, the oxygen concentration in the heating temperature range is set to 0.5 vol % or more and 5.0 vol % or less. The oxygen concentration in the heating temperature range is preferably 1.0 vol % or more. The oxygen concentration in the heating temperature range is more preferably 1.5 vol % or more. The oxygen concentration in the heating temperature range is preferably 4.5 vol % or less. The oxygen concentration in the heating temperature range is more preferably 4.0 vol % or less.

Here, the temperature in the heating temperature range is based on the surface temperature of the steel sheet. That is, it suffices to adjust the oxygen concentration to the above range when the surface temperature of the steel sheet is within the heating temperature range.

### [Annealing Temperature T₁: 750° C. Or More and 950° C. Or Less]

If the annealing temperature is below 750° C., it will not be possible to sufficiently secure the fraction of austenite during annealing, resulting in a decrease in the area ratio of martensite and making it difficult to achieve the desired TS. On the other hand, if the annealing temperature exceeds 950° C., annealing will take place in the austenite single phase region. In a case in which the surface structure during annealing is the austenite single phase, decarburization will not proceed, making it difficult to control the area ratio of martensite, in the region up to a depth of 10 μm from the surface of the base steel sheet, to be within the desired range. In addition, it will be difficult to include ferrite and retained austenite. Therefore, the annealing temperature T₁ is set to be 750° C. or more and 950° C. or less. The annealing temperature is preferably 770° C. or more. The annealing temperature is more preferably 780° C. or more. The annealing temperature is preferably 900° C. or less. The annealing temperature is more preferably 880° C. or less.

Here, the annealing temperature is the maximum arrival temperature during the annealing.

The holding time in the annealing temperature range (hereinafter also referred to as annealing time) is not particularly limited, but from the perspective of controlling the area ratios of ferrite and martensite in the base steel sheet to be within a predetermined range, the holding time is preferably 10 s or more. The holding time is preferably 600 s or less. In addition, the temperature during holding does not have to be constant.

[Retention time in the temperature range above 700° C. and Ti or less: 10 s or more and 500 s or less]

By increasing the retention time in the temperature range above 700° C. and T₁ or less, decarburization progresses through the oxygen in the atmosphere, making it possible to control the area ratio of martensite, in the region up to a depth of 10 μm from the surface of the base steel sheet, to be within the desired range. As the area ratio of martensite in the region up to a depth of 10 μm from the surface of the base steel sheet decreases, the diffusible hydrogen content in the low temperature region of the base steel sheet also decreases. As a result, it becomes possible to obtain high ultimate deformability, high local ductility, stretch flangeability, and bending ability. To obtain such an effect, the retention time in the temperature range above 700° C. and T₁ or less is set to 10 s or more. On the other hand, if the retention time in the temperature range above 700° C. and T₁ or less exceeds 500 s, the area ratio of martensite in the region up to a depth of 10 μm from the surface of the base steel sheet will decrease, making it difficult to achieve the desired TS. Therefore, the retention time in the temperature range above 700° C. and T₁ or less is set to 10 s or more and 500 s or less. The retention time in the temperature range above 700° C. and T₁ or less is preferably 15 s or more. This retention time is more preferably 20 s or more. The retention time in the temperature range above 700° C. and T₁ or less is preferably 400 s or less. This retention time is more preferably 300 s or less.

Here, the temperature in the heating temperature range is based on the surface temperature of the steel sheet.

### [Dew Point in the Temperature Range Above 700° C. And T₁ or Less: −30° C. Or More]

By increasing the dew point in the temperature range above 700° C. and T₁ or less, decarburization progresses through the oxygen in the atmosphere, making it possible to control the area ratio of martensite, in the region up to a depth of 10 μm from the surface of the base steel sheet, to be within the desired range. As the area ratio of martensite in the region up to a depth of 10 μm from the surface of the base steel sheet decreases, the diffusible hydrogen content in the low temperature region of the base steel sheet also decreases. As a result, it becomes possible to obtain high ultimate deformability, high local ductility, stretch flangeability, and bending ability. To obtain such an effect, the dew point in the annealing temperature range is set to −30° C. or more. No upper limit is placed on the dew point in the annealing temperature range, but from the perspective of ensuring the desired TS, the dew point in the annealing temperature range is preferably 15° C. or less. The dew point in the annealing temperature range is more preferably 5° C. or less.

Here, the temperature in the annealing temperature range is based on the surface temperature of the steel sheet. That is, it suffices to adjust the dew point to the above range when the surface temperature of the steel sheet is within the annealing temperature range.

The oxygen concentration in the annealing temperature range is not particularly limited, but from the perspective of controlling the area ratio of martensite in the region up to a depth of 10 μm from the surface of the base steel sheet to be within a predetermined range, the oxygen concentration is preferably 2 volume ppm or more. The oxygen concentration is preferably 30 volume ppm or less. In addition, the temperature during holding does not have to be constant.

After the above annealing, the cold-rolled steel sheet is cooled. The conditions at this time are not particularly limited, and known conditions can be adopted. For example, the average cooling rate in the temperature range of T₁ or less and 500° C. or more is not particularly limited, but from the perspective of controlling the area ratio of ferrite and martensite in the base steel sheet to be within a predetermined range, the average cooling rate is preferably 5° C./s or more. The average cooling rate is preferably 50° C./s or less.

### [2-7 Hot-Dip Galvanizing Treatment]

Next, the cold-rolled steel sheet is subjected to hot-dip galvanizing treatment. After the hot-dip galvanizing treatment, an alloying treatment may be performed.

The hot-dip galvanizing treatment can be performed in a temperature range of T₁ or less and 400° C. or more. The cold-rolled steel sheet may be cooled to below 400° C., and the steel sheet temperature may then be raised again to 400° C. or more before the treatment.

Annealing, cooling, and coating or plating treatment may be continuously performed on one line (CGL: Continuous Galvanizing Line). For example, after annealing, the cold-rolled steel sheet is cooled to a temperature range of about 500° C. Next, the cold-rolled steel sheet is passed to the steel strip exit side of the cooling zone and is further cooled while being moved into a hot-dip galvanizing bath through a snout, whose lead end is immersed in the hot-dip galvanizing bath. The time from the end of cooling of the cold-rolled steel sheet to its entry into the hot-dip galvanizing bath is not particularly limited, but from the perspective of controlling the area ratio of ferrite and martensite to be within a predetermined range, this time is preferably 300 seconds or less. Immediately before the connection part between the cooling zone and the snout, a roller is provided to change the traveling direction of the cold-rolled steel sheet for entry into the snout, and the cold-rolled steel sheet enters the snout after passing through the roller. Next, the cold-rolled steel sheet guided through the snout to the hot-dip galvanizing bath is immersed in the hot-dip galvanizing bath and subjected to hot-dip galvanizing treatment to become a galvanized steel sheet.

In the hot-dip galvanizing treatment, for example, the cold-rolled steel sheet is immersed in a hot-dip galvanizing bath at a temperature of 440° C. or more and 500° C. or less. It is preferable to use a hot-dip galvanizing bath with a composition in which the Al content is 0.10 mass % or more and 0.23 mass % or less, with the balance being Zn and inevitable impurities.

In addition, after the hot-dip galvanizing treatment as described above, an alloying treatment may be performed in a temperature range of 460° C. or more and 600° C. or less. If the alloying treatment temperature is below 460° C., the Zn—Fe alloying rate becomes excessively slow, resulting in decreased productivity. On the other hand, when the alloying treatment temperature exceeds 600° C., untransformed austenite may transform into pearlite, resulting in a decrease in TS and El. Therefore, the alloying treatment temperature is preferably 460° C. or more and 600° C. or less. The alloying treatment temperature is preferably 470° C. or more. The alloying treatment temperature is preferably 560° C. or less.

In addition, the coating weight is preferably 20 g/m² to 80 g/m² per side (in the case of double-sided coating). In addition, the Fe concentration in the coated layer as a result of applying the alloying treatment described below to the galvannealed steel sheet (GA) is preferably 7 mass % to 15 mass %. The coating weight of the coating can be adjusted by performing gas wiping or the like after the hot-dip galvanizing treatment.

### [2-8] Cooling

The coated steel sheet after the hot-dip galvanizing treatment, that is, the coated steel sheet that has undergone hot-dip galvanizing treatment or hot-dip galvanizing treatment and alloying treatment, is cooled.

The cooling conditions are not particularly limited, and known conditions can be applied. For example, after the hot-dip galvanizing treatment or alloying treatment is completed, the average cooling rate to the below-described holding temperature or cooling stop temperature and the cooling rate after the below-described holding or reheating are not particularly limited, but from the perspective of further improving TS, these rates are preferably 2° C./s or more. These rates are more preferably 5° C./s or more. In addition, due to production technology constraints, the average cooling rate is preferably 50° C./s or less. The average cooling rate is more preferably 40° C./s or less.

The cooling method is not particularly limited, and methods such as such as gas jet cooling, mist cooling, water cooling, and air cooling can be applied.

### [Holding Temperature During Cooling of the Coated Steel Sheet: 100° C. Or More and 450° C. Or Less (Preferred Condition)]

During cooling, the coated steel sheet may be held for 5 seconds or more in the temperature range of 100° C. or more and 450° C. or less and then cooled.

By holding during the cooling of the coated steel sheet, hydrogen desorption from the coated or plated steel sheet is promoted, and the diffusible hydrogen content in the low temperature region of the base steel sheet is reduced. From this perspective, the holding temperature during the cooling of the coated steel sheet is preferably 100° C. or more. The holding temperature is more preferably 130° C. or more. The holding temperature is even more preferably 150° C. or more. On the other hand, if the holding temperature during the cooling of the coated steel sheet exceeds 450° C., the area ratio of martensite decreases, resulting in a decrease in TS. Therefore, the holding temperature during the cooling of the coated steel sheet is preferably 450° C. or less. The holding temperature is more preferably 400° C. or less. The holding temperature is even more preferably 350° C. or less.

### [Holding Time During Cooling of the Coated Steel Sheet: 5 Seconds or More (Preferred Condition)]

By holding during the cooling of the coated steel sheet, hydrogen desorption from the coated or plated steel sheet is promoted, and the diffusible hydrogen content in the low temperature region of the base steel sheet is reduced. From this perspective, the holding time during the cooling of the coated steel sheet is preferably 5 seconds or more. The holding time is more preferably 10 seconds or more. The holding time is even more preferably 15 seconds or more. No upper limit is placed on the holding time during the cooling of the coated steel sheet, but from the perspective of controlling the area ratio of ferrite and martensite in the base steel sheet to be within a predetermined range, the holding time is preferably 300 seconds or less. The holding time is more preferably 100 seconds or less.

### [Cooling Stop Temperature During Cooling of the Coated Steel Sheet: 300° C. Or Less (Preferred Condition)]

During cooling of the coated steel sheet, cooling may be stopped at 300° C. or less, and the coated steel sheet may then be reheated to a temperature range of (cooling stop temperature+50° C.) or more and 450° C. or less, held for 5 seconds or more, and then cooled.

During the cooling of the coated steel sheet, by cooling to a temperature at or below the martensite transformation start temperature and then reheating, hydrogen desorption from the coated steel sheet is promoted, and the diffusible hydrogen content in the low temperature region of the base steel sheet is reduced. From this perspective, the cooling stop temperature during the cooling of the coated steel sheet is preferably 300° C. or less. The cooling stop temperature is more preferably 250° C. or less. The cooling stop temperature is even more preferably 150° C. or less. No lower limit is placed on the cooling stop temperature during the cooling of the galvanized steel sheet, but due to production technology constraints, the cooling stop temperature is preferably 10° C. or more. The cooling stop temperature is more preferably 30° C. or more.

### [Reheating Temperature of Coated Steel Sheet: (Cooling Stop Temperature+50° C.) or More and 450° C. Or Less (Preferred Condition)]

By reheating the coated steel sheet after cooling, hydrogen desorption from the coated steel sheet is promoted, and the diffusible hydrogen content in the low temperature region of the base steel sheet is reduced. From this perspective, the reheating temperature of the coated steel sheet is preferably set to (cooling stop temperature+50° C.) or more. The reheating temperature is more preferably (cooling stop temperature+80° C.) or more. The reheating temperature is even more preferably (cooling stop temperature+100° C.) or more. If the reheating temperature of the galvanized steel sheet exceeds 450° C., the area ratio of martensite decreases, lowering the TS. Therefore, the reheating temperature of the coated steel sheet is preferably 450° C. or less. The reheating temperature is more preferably 400° C. or less. The reheating temperature is even more preferably 350° C. or less.

### [Holding Time at Reheating Temperature of Coated Steel Sheet: 5 s or More (Preferred Condition)]

By holding at the reheating temperature after cooling the coated steel sheet, hydrogen desorption from the coated steel sheet is promoted, and the diffusible hydrogen content in the low temperature region of the base steel sheet is reduced. From this perspective, the holding time at the reheating temperature of the coated steel sheet is preferably 5 seconds or more. The holding time is more preferably 10 seconds or more. The holding time is even more preferably 15 seconds or more. No upper limit is placed on the holding time at the reheating temperature of the coated steel sheet, but from the perspective of controlling the area ratio of ferrite and martensite in the base steel sheet to be within a predetermined range, the holding time is preferably 300 seconds or less. The holding time is more preferably 100 seconds or less.

After the above cooling, rolling with an elongation rate of 0.05% or more and 1.00% or less is preferably applied to the coated steel sheet. By performing rolling with an elongation rate of 0.05% or more after cooling, cracks can be introduced into the hot-dip galvanized layer, resulting in further reduction of the diffusible hydrogen content in the low temperature region of the base steel sheet. When performing rolling after cooling, the elongation rate of the rolling is preferably 0.05% or more. The elongation rate is more preferably 0.10% or more.

On the other hand, if rolling with an elongation rate exceeding 1.00% is performed after cooling, there is a risk that the area ratio of ferrite with the {001} orientation will increase, worsening the anisotropy of flange cracking. When performing rolling after cooling, the elongation rate of the rolling is preferably set to 1.00% or less. The elongation rate is more preferably 0.50% or less.

The above rolling after cooling may be performed on a device continuous with the continuous hot-dip galvanizing apparatus (online) or on a device that is discontinuous with the continuous hot-dip galvanizing apparatus (offline). The desired elongation rate may be achieved in one rolling, or rolling may be performed multiple times to achieve a total elongation rate of 0.05% or more and 1.00% or less.

The above rolling after cooling generally refers to temper rolling, but if an elongation rate equivalent to temper rolling can be imparted, a processing method such as tension leveling or repeated bending with rollers may be adopted.

The rolling treatment may be performed after cooling the coated steel sheet to near room temperature, or the rolling treatment may be performed at the time cooling of the galvanized steel sheet is stopped. Reheating treatment may subsequently be performed.

When hot-dip galvanized steel sheets are to be traded, they are usually cooled to room temperature before being traded.

Production conditions other than those described above are not particularly limited, and known conditions can be adopted.

### [3] Member and Method of Producing the Same

A member of the present disclosure and a method of producing the same are described.

The member of the present disclosure is a member made using the above-described hot-dip galvanized steel sheet of the present disclosure. The member can be produced by forming the hot-dip galvanized steel sheet of the present disclosure into a desired shape by press working or the like.

The hot-dip galvanized steel sheet of the present disclosure has high ductility, high stretch flangeability, and bendability, and has a TS of 980 MPa or more. Therefore, by applying the hot-dip galvanized steel sheet of the present disclosure or a member made from the hot-dip galvanized steel sheet to automobile frame structural components or reinforcement parts of automobiles, for example, it is possible to improve fuel efficiency through automotive body weight reduction, which has significant industrial value.

### EXAMPLES

The present disclosure will be described in further detail below with reference to Examples. The present disclosure is not, however, limited to these Examples.

### [Test Nos. 1 to 47]

Steel slabs (steel materials) having the chemical compositions illustrated in Table 1, with the balance being Fe and inevitable impurities, were prepared by steelmaking in a converter and obtained as steel slabs by continuous casting. The obtained steel slab was heated to 1250° C., then rough rolled to obtain a sheet bar. Next, the obtained sheet bar was subjected to finish rolling at a rolling finish temperature of 900° C. and coiled under the set of conditions illustrated in Table 2 to obtain a hot-rolled steel sheet. After pickling the obtained hot-rolled steel sheet, cold rolling was performed under the set of conditions illustrated in Table 2 to obtain a cold-rolled steel sheet with a thickness of 1.4 mm.

The obtained cold-rolled steel sheet was subjected to annealing under the set of conditions illustrated in Table 2. Next, the cold-rolled steel sheet was subjected to the coating treatment of the type illustrated in Table 2 to obtain a coated steel sheet with a hot-dip galvanized layer on both sides.

The hot-dip galvanized steel sheet (GI) listed in the type of coating treatment in Table 2 underwent only hot-dip galvanizing treatment, meaning that no alloying treatment was performed. GA indicates that both hot-dip galvanizing treatment and alloying treatment were performed.

For GI, a hot-dip galvanizing bath containing Al: 0.20 mass %, with the balance being Zn and inevitable impurities, was used as the molten bath. For GA, a hot-dip galvanizing bath containing Al: 0.14 mass %, with the balance being Zn and inevitable impurities, was used. The molten bath temperature was set to 470° C. in both cases.

The coating weight was about 45 g/m² to 72 g/m² (double-sided coating) for GI and was about 45 g/m² (double-sided coating) for GA. In GA, the alloying treatment temperature was set to about 550° C.

The composition of the hot-dip galvanized layer of GI was Fe: 0.1 mass % to 1.0 mass %, Al: 0.2 mass % to 1.0 mass %, with the balance being Zn and inevitable impurities. The composition of the (alloyed) hot-dip galvanized layer of GA was Fe: 7 mass % to 15 mass %, Al: 0.1 mass % to 1.0 mass %, with the balance being Zn and inevitable impurities.

Next, for some of the coated steel sheets, a holding treatment or a reheating treatment after cooling was performed under the set of conditions illustrated in Table 2. The unspecified conditions were conditions according to a conventional method.

For the hot-dip galvanized steel sheet obtained in this way, the microstructure was identified in the region from the ¼ thickness position of the base steel sheet to a depth of 10 μm from the surface, and the diffusible hydrogen content in the low temperature region of the base steel sheet was measured. The results are listed in Table 3.

The chemical composition of the base steel sheet of the obtained steel sheet is substantially the same as that of the steel slab stage, and each conforming steel was within the range of the chemical composition of the present disclosure, whereas each comparative steel was outside the range of the chemical composition of the present disclosure.

For the obtained hot-dip galvanized steel sheet, the tensile property, ultimate deformability, stretch flangeability, and bendability were evaluated according to the following test methods. The results are listed in Table 3.

### [Tensile Test]

The tensile test was conducted in accordance with JIS Z 2241. That is, a JIS No. 5 test piece was collected from the obtained hot-dip galvanized steel sheet so that the direction orthogonal to the rolling direction of the steel sheet (C direction) became the longitudinal direction. Next, using the collected test piece, a tensile test was conducted under a set of conditions including a crosshead speed of 1.67×10⁻¹ mm/s, and YS, TS, El, and L.El were measured.

For TS, a value of 980 MPa or more was judged as passing.

In addition, the product of TS and El (TS×El) was calculated from the measured TS and El to obtain TS×El. A value of 13000 MPa. % or more for TS×El was judged as passing.

Furthermore, the product of TS and L.El (TS×L.El) was calculated from the measured TS and L.El to obtain TS×L.El. A value of 4500 MPa·% or more for TS×L.El was judged as passing.

### [Ultimate Deformability]

A test piece was collected in the same manner as above, and a tensile test was conducted. W₀: initial sheet width, W: width at the fracture part, T: initial sheet thickness, and T₀: thickness at the fracture part were determined, and the ultimate deformability ε₁ was obtained from the following expressions.

$${ε}_{w} = ln ( W / {W}_{0} )$$

$${ε}_{t} = ln ( T / {T}_{0} )$$

$${ε}_{l} = - ( {ε}_{w} + {ε}_{t} )$$

### <<Hole Expanding Test>>

A hole expanding test was conducted in accordance with JIS Z 2256. That is, the obtained hot-dip galvanized steel sheet was sheared to 100 mm×100 mm, and then a hole with a diameter of 10 mm was punched into the sheared steel sheet with a clearance of 12.5%. Next, using a die with an inner diameter of 75 mm, the steel sheet was held down with a blank holding force of 9 tonnes (88.26 kN), and in that state, a cone punch with an apex angle of 60° was pushed into the hole, and the hole diameter at the limit of crack occurrence was measured. Then, the (limit) hole expansion ratio (%) was determined by the following expression.

$$( Limit ) hole expansion ratio : λ ( \% ) = \{ ( {D}_{f} - {D}_{0} ) / {D}_{0} \} \times 100$$

Here, D_{f} is the hole diameter at the time of crack occurrence (mm), and D₀ is the initial hole diameter (mm). The (limit) hole expansion ratios of the three sheared steel types were measured, and the average value was taken as λ. The stretch flangeability was judged to be passing when λ was 30% or more.

### [Bend Test]

A bend test was conducted in accordance with JIS Z 2248. From the obtained hot-dip galvanized steel sheet, a strip-shaped test piece with a width of 30 mm and a length of 100 mm was collected so that the direction parallel to the rolling direction (L direction) of the steel sheet became the axial direction in the bend test. Subsequently, a 90° V-bend test was conducted under a set of conditions including a pressing load of 100 kN and a holding time of 5 seconds. In the present disclosure, the bendability was evaluated by the pass rate of the bend test. The bend test was carried out on five samples at the maximum R where the value R/t obtained by dividing the bending radius (R) by the sheet thickness (t) was 5 or less (for example, when the sheet thickness was 1.4 mm, the bending radius was 7.0 mm). Next, the ridge of the tip of the bend test specimen was evaluated for the presence of cracks. If none of the five samples was cracked, the bendability was judged to be “excellent”.

If one or more samples among the 5 samples had microfissures of less than 200 μm, the bendability was judged to be “good”. Furthermore, if one or more samples among the 5 samples had microfissures of 200 μm or more, the bendability was judged to be “poor”. Here, the presence of cracks was evaluated by measuring the ridge of the tip of the bend test specimen using a digital microscope (RH-2000: produced by Hirox Co., Ltd.) at 40× magnification.

TABLE 1

| Steel | | | | | | | | | | | | | | | | |
|---|---|---|---|---|---|---|---|---|---|---|---|---|---|---|---|---|
| sample | Chemical composition (mass %)* | | | | | | | | | | | | | | | |
| ID | C | Si | Mn | P | S | Al | N | O | Ti | Nb | V | Ta | W | B | Cr | Mo |
| A | 0.114 | 0.54 | 2.46 | 0.021 | 0.0023 | 0.025 | 0.0034 | 0.0005 | — | — | — | — | — | — | — | — |
| B | 0.205 | 0.59 | 2.86 | 0.009 | 0.0015 | 0.045 | 0.0032 | 0.0011 | — | — | — | — | — | — | — | — |
| C | 0.091 | 0.58 | 2.70 | 0.038 | 0.0022 | 0.049 | 0.0026 | 0.0009 | — | — | — | — | — | — | — | — |
| D | 0.236 | 0.18 | 2.73 | 0.009 | 0.0018 | 0.033 | 0.0032 | 0.0007 | — | — | — | — | — | — | — | — |
| E | 0.025 | 0.63 | 2.75 | 0.018 | 0.0050 | 0.045 | 0.0028 | 0.0008 | — | — | — | — | — | — | — | — |
| F | 0.100 | 2.56 | 2.71 | 0.036 | 0.0035 | 0.036 | 0.0026 | 0.0007 | — | — | — | — | — | — | — | — |
| G | 0.098 | 0.65 | 0.07 | 0.022 | 0.0010 | 0.042 | 0.0032 | 0.0005 | — | — | — | — | — | — | — | — |
| H | 0.097 | 0.63 | 5.08 | 0.022 | 0.0038 | 0.042 | 0.0029 | 0.0006 | — | — | — | — | — | — | — | — |
| I | 0.112 | 0.58 | 2.43 | 0.008 | 0.0005 | 0.025 | 0.0048 | 0.0009 | 0.030 | — | — | — | — | — | — | — |
| J | 0.110 | 0.44 | 2.53 | 0.038 | 0.0016 | 0.049 | 0.0053 | 0.0005 | — | 0.099 | — | — | — | — | — | — |
| K | 0.120 | 0.53 | 2.42 | 0.022 | 0.0033 | 0.044 | 0.0026 | 0.0007 | — | — | 0.037 | — | — | — | — | — |
| L | 0.121 | 0.50 | 2.58 | 0.022 | 0.0037 | 0.024 | 0.0043 | 0.0010 | — | — | — | 0.04 | 0.02 | — | — | — |
| M | 0.082 | 0.60 | 2.75 | 0.021 | 0.0043 | 0.038 | 0.0036 | 0.0004 | — | 0.020 | — | 0.08 | — | — | — | — |
| N | 0.117 | 0.40 | 2.46 | 0.026 | 0.0024 | 0.027 | 0.0048 | 0.0004 | 0.023 | — | — | — | — | 0.0022 | — | — |
| O | 0.084 | 0.66 | 2.65 | 0.033 | 0.0008 | 0.028 | 0.0033 | 0.0009 | — | — | — | — | — | — | 0.67 | — |
| P | 0.114 | 0.51 | 2.52 | 0.025 | 0.0036 | 0.048 | 0.0034 | 0.0007 | — | — | — | — | — | — | — | 0.11 |
| Q | 0.086 | 0.52 | 2.78 | 0.025 | 0.0026 | 0.038 | 0.0029 | 0.0007 | — | — | — | — | — | — | — | — |
| R | 0.128 | 0.47 | 2.43 | 0.022 | 0.0008 | 0.028 | 0.0033 | 0.0011 | — | — | — | — | — | — | — | — |
| S | 0.130 | 0.57 | 2.44 | 0.046 | 0.0025 | 0.047 | 0.0034 | 0.0010 | — | — | — | — | — | — | — | — |
| T | 0.123 | 0.53 | 2.50 | 0.046 | 0.0002 | 0.021 | 0.0030 | 0.0010 | — | — | — | — | — | — | — | — |
| U | 0.187 | 0.21 | 3.21 | 0.006 | 0.0029 | 0.020 | 0.0044 | 0.0012 | — | — | — | — | — | — | — | — |
| V | 0.118 | 0.46 | 2.48 | 0.037 | 0.0025 | 0.034 | 0.0033 | 0.0010 | — | — | — | — | — | — | — | — |
| W | 0.121 | 0.43 | 2.54 | 0.026 | 0.0002 | 0.033 | 0.0041 | 0.0003 | — | — | — | — | — | — | — | — |
| X | 0.097 | 0.68 | 2.69 | 0.012 | 0.0046 | 0.032 | 0.0047 | 0.0011 | — | — | — | — | — | — | — | — |
| Y | 0.125 | 0.52 | 2.41 | 0.046 | 0.0003 | 0.023 | 0.0026 | 0.0022 | — | — | — | — | — | — | — | — |
| Z | 0.050 | 0.51 | 2.62 | 0.017 | 0.0013 | 0.043 | 0.0027 | 0.0010 | — | — | — | — | — | — | — | — |
| a | 0.507 | 0.68 | 2.60 | 0.025 | 0.0006 | 0.039 | 0.0041 | 0.0003 | — | — | — | — | — | — | — | — |
| b | 0.089 | 0.02 | 2.69 | 0.015 | 0.0013 | 0.029 | 0.0038 | 0.0007 | — | — | — | — | — | — | — | — |
| c | 0.083 | 0.00 | 2.77 | 0.013 | 0.0010 | 0.031 | 0.0047 | 0.0009 | — | — | — | — | — | — | — | — |
| d | 0.088 | 0.50 | 0.95 | 0.004 | 0.0008 | 0.022 | 0.0025 | 0.0012 | 0.018 | — | — | — | — | 0.0005 | — | — |
| e | 0.126 | 0.52 | 2.55 | 0.007 | 0.0033 | 0.048 | 0.0025 | 0.0003 | 0.100 | — | — | — | — | — | — | — |
| f | 0.113 | 1.12 | 2.56 | 0.009 | 0.0003 | 0.011 | 0.0037 | 0.0013 | — | 0.100 | — | — | — | — | — | — |
| g | 0.122 | 0.43 | 2.48 | 0.043 | 0.0045 | 0.026 | 0.0035 | 0.0012 | 0.025 | — | — | — | — | 0.0080 | — | — |
| h | 0.124 | 0.55 | 2.49 | 0.025 | 0.0028 | 0.750 | 0.0046 | 0.0005 | — | — | — | — | — | — | 0.80 | — |
| i | 0.129 | 0.40 | 2.52 | 0.045 | 0.0032 | 0.036 | 0.0037 | 0.0007 | — | — | — | — | — | — | — | 0.80 |
| j | 0.125 | 0.54 | 2.49 | 0.004 | 0.0018 | 0.028 | 0.0044 | 0.0006 | — | — | — | — | — | — | — | — |
| k | 0.124 | 0.49 | 2.47 | 0.034 | 0.0013 | 0.044 | 0.0029 | 0.0005 | — | — | — | — | — | — | — | — |
| l | 0.129 | 0.55 | 2.57 | 0.031 | 0.0036 | 0.046 | 0.0037 | 0.0009 | — | — | — | — | — | — | — | — |
| m | 0.116 | 0.47 | 2.42 | 0.037 | 0.0014 | 0.048 | 0.0048 | 0.0005 | — | — | — | — | — | — | — | — |

| Steel | | | | | | | | | | | | | |
|---|---|---|---|---|---|---|---|---|---|---|---|---|---|
| sample | Chemical composition (mass %)* | | | | | | | | | | | | |
| ID | Ni | Co | Cu | Sn | Sb | Ca | Mg | REM | Zr | Te | Hf | Bi | Notes |
| A | — | — | — | — | — | — | — | — | — | — | — | — | Conforming |
| | | | | | | | | | | | | | steel |
| B | — | — | — | — | — | — | — | — | — | — | — | — | Conforming |
| | | | | | | | | | | | | | steel |
| C | — | — | — | — | — | — | — | — | — | — | — | — | Conforming |
| | | | | | | | | | | | | | steel |
| D | — | — | — | — | — | — | — | — | — | — | — | — | Conforming |
| | | | | | | | | | | | | | steel |
| E | — | — | — | — | — | — | — | — | — | — | — | — | Comparative |
| | | | | | | | | | | | | | steel |
| F | — | — | — | — | — | — | — | — | — | — | — | — | Comparative |
| | | | | | | | | | | | | | steel |
| G | — | — | — | — | — | — | — | — | — | — | — | — | Comparative |
| | | | | | | | | | | | | | steel |
| H | — | — | — | — | — | — | — | — | — | — | — | — | Comparative |
| | | | | | | | | | | | | | steel |
| I | — | — | — | — | — | — | — | — | — | — | — | — | Conforming |
| | | | | | | | | | | | | | steel |
| J | — | — | — | — | — | — | — | — | — | — | — | — | Conforming |
| | | | | | | | | | | | | | steel |
| K | — | — | — | — | — | — | — | — | — | — | — | — | Conforming |
| | | | | | | | | | | | | | steel |
| L | — | — | — | — | — | — | — | — | — | — | — | — | Conforming |
| | | | | | | | | | | | | | steel |
| M | — | — | — | — | — | — | — | — | — | — | — | — | Conforming |
| | | | | | | | | | | | | | steel |
| N | — | — | — | — | — | — | — | — | — | — | — | — | Conforming |
| | | | | | | | | | | | | | steel |
| O | — | — | — | — | — | — | — | — | — | — | — | — | Conforming |
| | | | | | | | | | | | | | steel |
| P | — | — | — | — | — | — | — | — | — | — | — | — | Conforming |
| | | | | | | | | | | | | | steel |
| Q | 0.15 | — | — | — | — | — | — | — | — | — | — | — | Conforming |
| | | | | | | | | | | | | | steel |
| R | — | 0.008 | — | — | — | — | — | — | — | — | — | — | Conforming |
| | | | | | | | | | | | | | steel |
| S | — | — | 0.17 | — | — | — | — | — | — | — | — | — | Conforming |
| | | | | | | | | | | | | | steel |
| T | — | — | — | 0.099 | — | — | — | — | — | — | — | — | Conforming |
| | | | | | | | | | | | | | steel |
| U | — | — | — | — | 0.010 | — | — | — | — | — | — | — | Conforming |
| | | | | | | | | | | | | | steel |
| V | — | — | — | — | — | 0.0014 | — | — | — | — | — | — | Conforming |
| | | | | | | | | | | | | | steel |
| W | — | — | — | — | — | — | 0.0050 | 0.0048 | — | — | — | — | Conforming |
| | | | | | | | | | | | | | steel |
| X | — | — | — | — | — | — | — | — | 0.078 | — | — | — | Conforming |
| | | | | | | | | | | | | | steel |
| Y | — | — | — | — | — | — | — | — | — | 0.075 | 0.07 | 0.098 | Conforming |
| | | | | | | | | | | | | | steel |
| Z | — | — | — | — | — | — | — | — | — | — | — | — | Conforming |
| | | | | | | | | | | | | | steel |
| a | — | — | — | — | — | — | — | — | — | — | — | — | Comparative |
| | | | | | | | | | | | | | steel |
| b | — | — | — | — | — | — | — | — | — | — | — | — | Conforming |
| | | | | | | | | | | | | | steel |
| c | — | — | — | — | — | — | — | — | — | — | — | — | Comparative |
| | | | | | | | | | | | | | steel |
| d | — | — | — | — | — | — | — | — | — | — | — | — | Conforming |
| | | | | | | | | | | | | | steel |
| e | — | — | — | — | — | — | — | — | — | — | — | — | Conforming |
| | | | | | | | | | | | | | steel |
| f | — | — | — | — | — | — | — | — | — | — | — | — | Conforming |
| | | | | | | | | | | | | | steel |
| g | — | — | — | — | — | — | — | — | — | — | — | — | Conforming |
| | | | | | | | | | | | | | steel |
| h | — | — | — | — | — | — | — | — | — | — | — | — | Conforming |
| | | | | | | | | | | | | | steel |
| i | — | — | — | — | — | — | — | — | — | — | — | — | Conforming |
| | | | | | | | | | | | | | steel |
| j | 0.80 | — | — | — | — | — | — | — | — | — | — | — | Conforming |
| | | | | | | | | | | | | | steel |
| k | — | — | 0.80 | — | — | — | — | — | — | — | — | — | Conforming |
| | | | | | | | | | | | | | steel |
| l | — | — | — | — | 0.100 | — | — | — | — | — | — | — | Conforming |
| | | | | | | | | | | | | | steel |
| m | — | — | — | — | — | 0.0050 | — | — | — | — | — | — | Conforming |
| | | | | | | | | | | | | | steel |

*The balance is Fe and incidental impurities.
Underlined values are outside of the range.

TABLE 2

| | | | Cold rolling | | Annealing process | | | |
|---|---|---|---|---|---|---|---|---|
| | | | process | | Oxygen | | | |
| | | | | Unit | concentra- | | | |
| | | | | tension | tion in | | Retention | |
| | | Hot | | between | temperature | | time in | |
| | | rolling | | final pass | range of | | temperature | Dew point in |
| | | process | Cumulative | and the pass | 250° C. or | | range | temperature |
| | | Coiling | rolling | immediately | more and | Annealing | above | range above |
| | Steel | temper- | reduction | before the | 700° C. | temper- | 700° C. | 700° C. and |
| | sample | ature | ratio | final pass | or less | ature T₁ | and T₁ or | T₁ or less |
| No. | ID | (° C.) | (%) | (kgf/mm²) | (volume %) | (° C.) | less (s) | (° C.) |
| 1 | A | 550 | 50 | 27 | 2.0 | 810 | 30 | −15 |
| 2 | A | 550 | 50 | 27 | 2.0 | 810 | 30 | −15 |
| 3 | A | 550 | 50 | 27 | 2.0 | 810 | 30 | −15 |
| 4 | B | 500 | 40 | 27 | 2.5 | 850 | 120 | −20 |
| 5 | B | 500 | 40 | 27 | 2.5 | 850 | 120 | −20 |
| 6 | B | 500 | 40 | 27 | 2.5 | 850 | 120 | −20 |
| 7 | C | 600 | 50 | 27 | 3.0 | 800 | 90 | −10 |
| 8 | C | 600 | 50 | 27 | 3.0 | 800 | 90 | −10 |
| 9 | C | 600 | 50 | 27 | 3.0 | 800 | 90 | −10 |
| 10 | C | 350 | 50 | 27 | 2.0 | 800 | 90 | −10 |
| 11 | C | 750 | 50 | 27 | 2.0 | 800 | 90 | −10 |
| 12 | C | 600 | 25 | 37 | 2.0 | 800 | 90 | −10 |
| 13 | C | 600 | 50 | 7 | 2.0 | 800 | 90 | −10 |
| 14 | C | 600 | 50 | 27 | 0.2 | 800 | 90 | −10 |
| 15 | C | 600 | 50 | 27 | 6.0 | 800 | 90 | −10 |
| 16 | C | 600 | 50 | 27 | 2.0 | 730 | 90 | −10 |
| 17 | C | 600 | 50 | 27 | 2.0 | 970 | 90 | −10 |
| 18 | C | 600 | 50 | 27 | 2.0 | 800 | 5 | −10 |
| 19 | C | 600 | 50 | 27 | 2.0 | 800 | 800 | −10 |
| 20 | C | 600 | 50 | 27 | 2.0 | 800 | 90 | −40 |
| 21 | D | 450 | 50 | 27 | 1.5 | 900 | 150 | −5 |
| 22 | E | 550 | 55 | 25 | 3.0 | 820 | 60 | −5 |
| 23 | F | 550 | 55 | 25 | 3.0 | 820 | 60 | −5 |
| 24 | G | 550 | 55 | 25 | 3.0 | 820 | 60 | −5 |
| 25 | H | 550 | 55 | 25 | 3.0 | 820 | 60 | −5 |
| 26 | I | 600 | 55 | 25 | 2.0 | 830 | 200 | −15 |
| 27 | J | 600 | 60 | 22 | 1.5 | 820 | 100 | −25 |
| 28 | K | 600 | 50 | 27 | 2.0 | 820 | 200 | −10 |
| 29 | L | 600 | 55 | 25 | 3.0 | 820 | 100 | −5 |
| 30 | M | 650 | 55 | 25 | 2.5 | 780 | 150 | −15 |
| 31 | N | 700 | 55 | 25 | 4.0 | 820 | 100 | −10 |
| 32 | O | 600 | 65 | 20 | 3.0 | 790 | 150 | −10 |
| 33 | P | 600 | 60 | 22 | 2.0 | 840 | 100 | −10 |
| 34 | Q | 550 | 65 | 20 | 3.5 | 820 | 200 | −10 |
| 35 | R | 550 | 35 | 32 | 3.0 | 800 | 250 | −5 |
| 36 | S | 550 | 55 | 25 | 2.5 | 820 | 200 | −15 |
| 37 | T | 550 | 55 | 25 | 2.0 | 800 | 200 | −10 |
| 38 | U | 600 | 60 | 22 | 3.0 | 890 | 100 | −10 |
| 39 | V | 600 | 55 | 25 | 2.5 | 830 | 200 | −15 |
| 40 | W | 400 | 60 | 22 | 1.5 | 830 | 150 | 10 |
| 41 | X | 600 | 65 | 20 | 2.0 | 810 | 200 | −10 |
| 42 | Y | 650 | 55 | 25 | 2.0 | 820 | 100 | −15 |
| 43 | Z | 550 | 55 | 25 | 3.0 | 820 | 60 | −5 |
| 44 | a | 550 | 55 | 25 | 3.0 | 820 | 60 | −5 |
| 45 | b | 550 | 55 | 25 | 3.0 | 900 | 60 | −5 |
| 46 | c | 550 | 55 | 25 | 3.0 | 900 | 60 | −5 |
| 47 | d | 550 | 55 | 25 | 3.0 | 820 | 60 | −5 |
| 48 | e | 550 | 55 | 25 | 3.0 | 820 | 60 | 5 |
| 49 | f | 550 | 55 | 25 | 3.0 | 820 | 60 | 5 |
| 50 | g | 550 | 55 | 25 | 3.0 | 820 | 60 | 5 |
| 51 | h | 550 | 55 | 25 | 3.0 | 820 | 60 | 5 |
| 52 | i | 550 | 55 | 25 | 3.0 | 820 | 60 | 5 |
| 53 | j | 550 | 55 | 25 | 3.0 | 820 | 60 | 5 |
| 54 | k | 550 | 55 | 25 | 3.0 | 820 | 60 | 5 |
| 55 | l | 550 | 55 | 25 | 3.0 | 820 | 60 | 5 |
| 56 | m | 550 | 55 | 25 | 3.0 | 820 | 60 | 5 |

| | | | | Reheating process | | | |
|---|---|---|---|---|---|---|---|
| | Cooling process | | | | Holding | | |
| | Holding | | | | time at | Coating | |
| | temper- | | Cooling stop | Reheating | reheating | treatment | |
| | ature | Holding | temperature | temperature | temperature | conditions | |
| No. | (° C.) | time (s) | (° C.) | (° C.) | (s) | Type | Notes |
| 1 | — | — | room | — | — | GA | Example |
| | | | temperature | | | | |
| 2 | 200 | 70 | room | — | — | GA | Example |
| | | | temperature | | | | |
| 3 | — | — | 50 | 300 | 50 | GA | Example |
| 4 | — | — | room | — | — | GA | Example |
| | | | temperature | | | | |
| 5 | 200 | 100 | room | — | — | GA | Example |
| | | | temperature | | | | |
| 6 | — | — | room | 250 | 70 | GA | Example |
| | | | temperature | | | | |
| 7 | — | — | room | — | — | GA | Example |
| | | | temperature | | | | |
| 8 | 150 | 150 | room | — | — | GA | Example |
| | | | temperature | | | | |
| 9 | — | — | 50 | 200 | 40 | GA | Example |
| 10 | — | — | 50 | 200 | 40 | GA | Comp. |
| | | | | | | | Example |
| 11 | — | — | 50 | 200 | 40 | GA | Comp. |
| | | | | | | | Example |
| 12 | — | — | 50 | 200 | 40 | GA | Comp. |
| | | | | | | | Example |
| 13 | — | — | 50 | 200 | 40 | GA | Comp. |
| | | | | | | | Example |
| 14 | — | — | 50 | 200 | 40 | GA | Comp. |
| | | | | | | | Example |
| 15 | — | — | 50 | 200 | 40 | GA | Comp. |
| | | | | | | | Example |
| 16 | — | — | 50 | 200 | 40 | GA | Comp. |
| | | | | | | | Example |
| 17 | — | — | 50 | 200 | 40 | GA | Comp. |
| | | | | | | | Example |
| 18 | — | — | 50 | 200 | 40 | GA | Comp. |
| | | | | | | | Example |
| 19 | — | — | 50 | 200 | 40 | GA | Comp. |
| | | | | | | | Example |
| 20 | — | — | 50 | 200 | 40 | GA | Comp. |
| | | | | | | | Example |
| 21 | — | — | room | 300 | 100 | GA | Example |
| | | | temperature | | | | |
| 22 | — | — | room | 150 | 120 | GI | Comp. |
| | | | temperature | | | | Example |
| 23 | — | — | room | 150 | 120 | GA | Comp. |
| | | | temperature | | | | Example |
| 24 | — | — | room | 150 | 120 | GI | Comp. |
| | | | temperature | | | | Example |
| 25 | — | — | room | 150 | 120 | GA | Comp. |
| | | | temperature | | | | Example |
| 26 | — | — | 50 | 200 | 90 | GA | Example |
| 27 | — | — | 100 | 300 | 100 | GI | Example |
| 28 | — | — | 50 | 250 | 100 | GA | Example |
| 29 | — | — | room | 300 | 50 | GI | Example |
| | | | temperature | | | | |
| 30 | — | — | room | — | — | GA | Example |
| | | | temperature | | | | |
| 31 | — | — | room | 200 | 100 | GA | Example |
| | | | temperature | | | | |
| 32 | — | — | room | — | — | GA | Example |
| | | | temperature | | | | |
| 33 | — | — | room | 250 | 100 | GI | Example |
| | | | temperature | | | | |
| 34 | — | — | room | 150 | 200 | GA | Example |
| | | | temperature | | | | |
| 35 | — | — | 100 | 200 | 100 | GI | Example |
| 36 | — | — | 50 | 250 | 100 | GI | Example |
| 37 | — | — | 50 | 250 | 100 | GA | Example |
| 38 | — | — | 50 | 300 | 30 | GA | Example |
| 39 | — | — | 50 | 250 | 100 | GI | Example |
| 40 | — | — | 150 | 250 | 100 | GA | Example |
| 41 | — | — | room | — | — | GA | Example |
| | | | temperature | | | | |
| 42 | — | — | 250 | 450 | 5 | GA | Example |
| 43 | — | — | room | 200 | 100 | GA | Example |
| | | | temperature | | | | |
| 44 | — | — | room | 200 | 100 | GA | Comp. |
| | | | temperature | | | | Example |
| 45 | — | — | room | 200 | 100 | GA | Example |
| | | | temperature | | | | |
| 46 | — | — | room | 200 | 100 | GA | Comp. |
| | | | temperature | | | | Example |
| 47 | — | — | room | 200 | 100 | GA | Example |
| | | | temperature | | | | |
| 48 | — | — | 50 | 250 | 50 | GA | Example |
| 19 | — | — | 50 | 250 | 50 | GA | Example |
| 50 | — | — | 50 | 250 | 50 | GA | Example |
| 51 | — | — | 50 | 250 | 50 | GA | Example |
| 52 | — | — | 50 | 250 | 50 | GA | Example |
| 53 | — | — | 50 | 250 | 50 | GA | Example |
| 54 | — | — | 50 | 250 | 50 | GA | Example |
| 55 | — | — | 50 | 250 | 50 | GA | Example |
| 56 | — | — | 50 | 250 | 50 | GA | Example |

Underlined values are outside of the range.

TABLE 3

| | | Steel microstructure of base steel sheet | | | | | | | | |
|---|---|---|---|---|---|---|---|---|---|---|
| | | | | | | Surface layer (region | | | | |
| | | | | | | up to depth of 10 μm) | | | Diffusible | |
| | | | | | | | Ratio to | | hydrogen | |
| | | | | | | | the area | | content | |
| | | | | | | | fraction | | in low | |
| | | Thickness at ¼ position | | | | | of M | | temperature | |
| | | Area | Area | Area | | Area | at ¼ | | region | |
| | Steel | ratio | ratio | ratio of | Residual | ratio | thickness | Residual | of base | Ultimate |
| | sample | of M | of α | retained | micro- | of M | position | micro- | steel sheet | deform- |
| No. | ID | (%) | (%) | γ (%) | structure | (%) | (%) | structure | (mass ppm) | ability |
| 1 | A | 61 | 35 | 2 | θ | 22 | 37 | α + θ | 0.009 | 1.28 |
| 2 | A | 55 | 39 | 3 | θ | 36 | 65 | α + θ | 0.003 | 1.08 |
| 3 | A | 52 | 42 | 3 | θ | 37 | 72 | α + θ | 0.009 | 0.79 |
| 4 | B | 96 | 0 | 2 | θ | 52 | 54 | α + B + θ | 0.007 | 0.88 |
| 5 | B | 91 | 4 | 3 | θ | 62 | 68 | α + B + θ | 0.003 | 0.72 |
| 6 | B | 91 | 2 | 3 | θ | 51 | 56 | α + B + θ | 0.004 | 1.00 |
| 7 | C | 50 | 43 | 4 | θ | 30 | 60 | α + θ | 0.005 | 1.46 |
| 8 | C | 45 | 50 | 3 | θ | 33 | 74 | α + θ | 0.002 | 1.72 |
| 9 | C | 53 | 39 | 4 | θ | 34 | 64 | α + θ | 0.006 | 1.86 |
| 10 | C | 53 | 39 | 5 | θ | 53 | 100 | α + θ | 0.017 | 0.09 |
| 11 | C | 42 | 52 | 4 | θ | 1 | 2 | α + θ | 0.009 | 1.23 |
| 12 | C | 45 | 47 | 4 | θ | 38 | 84 | α + θ | 0.018 | 0.06 |
| 13 | C | 45 | 49 | 5 | θ | 37 | 82 | α + θ | 0.017 | 0.08 |
| 14 | C | 45 | 46 | 5 | θ | 44 | 98 | α + θ | 0.018 | 0.05 |
| 15 | C | 42 | 52 | 4 | θ | 3 | 7 | α + θ | 0.008 | 1.80 |
| 16 | C | 21 | 73 | 4 | θ | 16 | 76 | α + θ | 0.005 | 1.74 |
| 17 | C | 100 | 0 | 0 | θ | 46 | 46 | α + θ | 0.018 | 0.07 |
| 18 | C | 44 | 47 | 4 | θ | 36 | 82 | α + θ | 0.018 | 0.06 |
| 19 | C | 51 | 43 | 4 | θ | 4 | 8 | α + θ | 0.007 | 1.62 |
| 20 | C | 53 | 39 | 5 | θ | 47 | 89 | α + θ | 0.019 | 0.05 |
| 21 | D | 85 | 10 | 2 | θ | 64 | 75 | α + B + θ | 0.003 | 0.99 |
| 22 | E | 22 | 72 | 4 | θ | 18 | 82 | α + θ | 0.005 | 1.27 |
| 23 | F | 43 | 41 | 12 | θ | 11 | 26 | α + θ | 0.017 | 1.76 |
| 24 | G | 18 | 74 | 3 | θ | 12 | 68 | α + θ | 0.003 | 1.49 |
| 25 | H | 48 | 45 | 4 | θ | 33 | 68 | α + θ | 0.018 | 1.43 |
| 26 | I | 58 | 34 | 3 | θ | 39 | 68 | α + θ | 0.003 | 1.05 |
| 27 | J | 55 | 40 | 3 | θ | 33 | 60 | α + θ | 0.007 | 1.33 |
| 28 | K | 55 | 39 | 4 | θ | 41 | 74 | α + θ | 0.007 | 1.15 |
| 29 | L | 59 | 37 | 3 | θ | 33 | 55 | α + θ | 0.008 | 1.43 |
| 30 | M | 44 | 48 | 4 | θ | 28 | 63 | α + θ | 0.009 | 1.01 |
| 31 | N | 65 | 31 | 2 | θ | 41 | 63 | α + θ | 0.010 | 0.85 |
| 32 | O | 41 | 52 | 4 | θ | 10 | 25 | α + θ | 0.007 | 1.58 |
| 33 | P | 59 | 34 | 3 | θ | 31 | 53 | α + θ | 0.005 | 1.32 |
| 34 | Q | 35 | 57 | 4 | θ | 24 | 69 | α + θ | 0.010 | 1.20 |
| 35 | R | 63 | 32 | 3 | θ | 50 | 79 | α + θ | 0.003 | 1.14 |
| 36 | S | 54 | 39 | 3 | θ | 22 | 40 | α + θ | 0.008 | 1.35 |
| 37 | T | 57 | 38 | 3 | θ | 37 | 65 | α + θ | 0.003 | 0.92 |
| 38 | U | 91 | 4 | 3 | θ | 30 | 33 | α + B + θ | 0.006 | 0.43 |
| 39 | V | 57 | 39 | 2 | θ | 34 | 59 | α + θ | 0.001 | 1.47 |
| 40 | W | 57 | 38 | 3 | θ | 43 | 76 | α + θ | 0.008 | 1.46 |
| 41 | X | 45 | 50 | 4 | θ | 31 | 69 | α + θ | 0.005 | 1.51 |
| 42 | Y | 57 | 38 | 3 | θ | 39 | 68 | α + θ | 0.005 | 1.25 |
| 43 | Z | 31 | 63 | 4 | θ | 18 | 58 | α + θ | 0.005 | 1.19 |
| 44 | a | 38 | 48 | 13 | θ | 22 | 58 | α + θ | 0.017 | 1.59 |
| 45 | b | 95 | 2 | 1 | θ | 75 | 79 | α + θ | 0.014 | 0.15 |
| 46 | c | 100 | 0 | 0 | θ | 83 | 83 | α + θ | 0.017 | 0.09 |
| 47 | d | 30 | 62 | 5 | θ | 21 | 70 | α + θ | 0.009 | 1.35 |
| 48 | e | 63 | 35 | 0 | θ | 25 | 40 | α + θ | 0.010 | 1.32 |
| 49 | f | 62 | 34 | 3 | θ | 24 | 39 | α + θ | 0.005 | 0.83 |
| 50 | g | 54 | 43 | 0 | θ | 21 | 39 | α + θ | 0.007 | 1.30 |
| 51 | h | 69 | 26 | 3 | θ | 27 | 39 | α + θ | 0.003 | 1.26 |
| 52 | i | 51 | 43 | 3 | θ | 20 | 39 | α + θ | 0.009 | 0.99 |
| 53 | j | 68 | 25 | 4 | θ | 26 | 38 | α + θ | 0.009 | 1.21 |
| 54 | k | 56 | 40 | 3 | θ | 23 | 41 | α + θ | 0.001 | 1.41 |
| 55 | l | 69 | 24 | 3 | θ | 44 | 64 | α + θ | 0.004 | 1.40 |
| 56 | m | 59 | 37 | 3 | θ | 22 | 37 | α + θ | 0.006 | 1.40 |

| | Mechanical properties | | | | | | | | |
|---|---|---|---|---|---|---|---|---|---|
| | | | | | | TS × | | | |
| | YS | TS | El | L.El | TS × El | L.El | λ | | |
| No. | (MPa) | (MPa) | (%) | (%) | (MPa · %) | (MPa · %) | (%) | Bendability | Notes |
| 1 | 919 | 1183 | 13 | 7 | 15379 | 8281 | 26 | good | Example |
| 2 | 906 | 1229 | 16 | 7 | 19664 | 8603 | 38 | excellent | Example |
| 3 | 958 | 1241 | 11 | 4 | 13651 | 4964 | 25 | excellent | Example |
| 4 | 1217 | 1476 | 10 | 3 | 14760 | 4428 | 21 | good | Example |
| 5 | 1160 | 1573 | 9 | 3 | 14157 | 4719 | 33 | excellent | Example |
| 6 | 1097 | 1477 | 8 | 4 | 11816 | 5908 | 27 | excellent | Example |
| 7 | 624 | 1041 | 21 | 8 | 21861 | 8328 | 23 | good | Example |
| 8 | 691 | 1025 | 19 | 9 | 19475 | 9225 | 36 | excellent | Example |
| 9 | 624 | 1034 | 17 | 7 | 17578 | 7238 | 28 | excellent | Example |
| 10 | 586 | 988 | 14 | 4 | 13832 | 3952 | 15 | poor | Comp. |
| | | | | | | | | | Example |
| 11 | 644 | 969 | 19 | 8 | 18411 | 7752 | 31 | excellent | Comp. |
| | | | | | | | | | Example |
| 12 | 711 | 1007 | 13 | 3 | 13091 | 3021 | 14 | poor | Comp. |
| | | | | | | | | | Example |
| 13 | 728 | 1034 | 14 | 4 | 14476 | 4136 | 15 | poor | Comp. |
| | | | | | | | | | Example |
| 14 | 727 | 988 | 10 | 4 | 9880 | 3952 | 15 | poor | Comp. |
| | | | | | | | | | Example |
| 15 | 608 | 975 | 13 | 10 | 12675 | 9750 | 35 | excellent | Comp. |
| | | | | | | | | | Example |
| 16 | 600 | 965 | 19 | 8 | 18335 | 7720 | 22 | excellent | Comp. |
| | | | | | | | | | Example |
| 17 | 639 | 1033 | 8 | 4 | 8264 | 4132 | 17 | poor | Comp. |
| | | | | | | | | | Example |
| 18 | 732 | 988 | 12 | 4 | 11856 | 3952 | 15 | poor | Comp. |
| | | | | | | | | | Example |
| 19 | 735 | 973 | 19 | 9 | 18487 | 8757 | 34 | excellent | Comp. |
| | | | | | | | | | Example |
| 20 | 659 | 1028 | 12 | 3 | 12336 | 3084 | 18 | poor | Comp. |
| | | | | | | | | | Example |
| 21 | 1174 | 1492 | 11 | 3 | 16412 | 4476 | 44 | excellent | Example |
| 22 | 746 | 964 | 15 | 7 | 14460 | 6748 | 38 | excellent | Comp. |
| | | | | | | | | | Example |
| 23 | 689 | 1049 | 14 | 3 | 14686 | 3147 | 16 | poor | Comp. |
| | | | | | | | | | Example |
| 24 | 641 | 957 | 17 | 10 | 16269 | 9570 | 23 | excellent | Comp. |
| | | | | | | | | | Example |
| 25 | 654 | 1046 | 12 | 4 | 12552 | 4184 | 15 | poor | Comp. |
| | | | | | | | | | Example |
| 26 | 1118 | 1189 | 10 | 7 | 11890 | 8323 | 42 | excellent | Example |
| 27 | 1039 | 1181 | 9 | 5 | 10629 | 5905 | 22 | excellent | Example |
| 28 | 851 | 1204 | 15 | 5 | 18060 | 6020 | 27 | excellent | Example |
| 29 | 802 | 1238 | 7 | 6 | 8666 | 7428 | 41 | excellent | Example |
| 30 | 624 | 1024 | 12 | 9 | 12288 | 9216 | 22 | excellent | Example |
| 31 | 807 | 1201 | 8 | 5 | 9608 | 6005 | 40 | excellent | Example |
| 32 | 670 | 1015 | 17 | 9 | 17255 | 9135 | 37 | good | Example |
| 33 | 1201 | 1193 | 12 | 4 | 14316 | 4772 | 41 | excellent | Example |
| 34 | 583 | 1007 | 13 | 10 | 13091 | 10070 | 36 | excellent | Example |
| 35 | 1030 | 1235 | 15 | 5 | 18525 | 6175 | 34 | excellent | Example |
| 36 | 979 | 1224 | 12 | 7 | 14688 | 8568 | 41 | excellent | Example |
| 37 | 943 | 1242 | 13 | 5 | 16146 | 6210 | 33 | excellent | Example |
| 38 | 1182 | 1506 | 8 | 3 | 12048 | 4518 | 44 | excellent | Example |
| 39 | 1070 | 1213 | 14 | 5 | 16982 | 6065 | 40 | excellent | Example |
| 40 | 1215 | 1235 | 12 | 6 | 14820 | 7410 | 22 | excellent | Example |
| 41 | 616 | 981 | 12 | 8 | 11772 | 7848 | 23 | good | Example |
| 42 | 1192 | 1195 | 8 | 5 | 9560 | 5975 | 22 | excellent | Example |
| 43 | 634 | 980 | 20 | 8 | 19600 | 7840 | 25 | excellent | Example |
| 44 | 728 | 1028 | 19 | 4 | 19532 | 4112 | 16 | poor | Comp. |
| | | | | | | | | | Example |
| 45 | 659 | 990 | 11 | 5 | 10890 | 4950 | 20 | good | Example |
| 46 | 605 | 1009 | 9 | 4 | 9081 | 4036 | 15 | poor | Comp. |
| | | | | | | | | | Example |
| 47 | 648 | 981 | 14 | 9 | 13734 | 8829 | 24 | excellent | Example |
| 48 | 897 | 1185 | 15 | 4 | 17775 | 4740 | 20 | good | Example |
| 49 | 929 | 1213 | 10 | 5 | 12130 | 6065 | 23 | good | Example |
| 50 | 1146 | 1198 | 17 | 4 | 20366 | 4792 | 20 | good | Example |
| 51 | 1190 | 1218 | 17 | 5 | 20706 | 6090 | 22 | good | Example |
| 52 | 1193 | 1215 | 12 | 5 | 14580 | 5532 | 21 | good | Example |
| 53 | 884 | 1222 | 15 | 5 | 18330 | 6110 | 24 | good | Example |
| 54 | 1055 | 1212 | 10 | 4 | 12120 | 4848 | 22 | good | Example |
| 55 | 1209 | 1255 | 15 | 4 | 18825 | 5057 | 24 | good | Example |
| 56 | 1079 | 1199 | 16 | 5 | 19184 | 5995 | 24 | good | Example |

Underlined values are outside of the range.
M: martensite,
α: ferrite,
B: bainite, retained
γ: retained austenite,
θ: cementite and/or metastable carbide

As illustrated in Table 3, all of the Examples had a TS of 980 MPa or more, high ductility, high stretch flangeability, and bendability, along with high local ductility. On the other hand, for the Comparative Examples, at least one of TS, ductility, stretch flangeability, bendability, and local ductility was not sufficient.

### [Test Nos. 48 to 71]

Steel slabs (steel materials) having the chemical compositions illustrated in Table 1, with the balance being Fe and inevitable impurities, were prepared by steelmaking in a converter and obtained as steel slabs by continuous casting. The obtained steel slab was heated to 1250° C., then rough rolled to obtain a sheet bar. Next, the obtained sheet bar was subjected to finish rolling at a rolling finish temperature of 900° C. and coiled under the set of conditions illustrated in Table 4 to obtain a hot-rolled steel sheet. After pickling the obtained hot-rolled steel sheet, cold rolling was performed under the set of conditions illustrated in Table 4 to obtain a cold-rolled steel sheet with a thickness of 1.4 mm.

For some cold-rolled steel sheets, metal electroplating treatment was performed. In the column for the presence or absence of metal electroplating treatment in Table 4 (plating type), an entry of Yes (Fe) indicates an example in which Fe-based electroplating treatment was performed, and an entry of (Ni) indicates an example in which Ni-based electroplating treatment was performed. The composition of the metal electroplating layer contained Fe: 95 mass % to 100 mass % for Fe-based electroplating and Ni: 95 mass % to 100 mass % for Ni-based electroplating, with the balance in each case being inevitable impurities.

Next, the cold-rolled steel sheet was subjected to the coating treatment of the type illustrated in Table 4 (GI, GA), resulting in a coated steel sheet with a hot-dip galvanized layer on both sides. The conditions for GI and GA were the same as above.

Next, for some of the coated steel sheets, a holding treatment or a reheating treatment after cooling was performed under the set of conditions illustrated in Table 4. The unspecified conditions were conditions according to a conventional method.

The chemical composition of the obtained base steel sheet of the steel sheet was substantially the same as the chemical composition at the steel slab stage, and each conforming steel was within the range of the chemical composition according to the above embodiment.

For the hot-dip galvanized steel sheets obtained in this manner, ultimate deformability, tensile properties, stretch flangeability, bendability, and the diffusible hydrogen content in the low temperature region were measured. The results are listed in Tables 5 and 6.

Furthermore, for the obtained hot-dip galvanized steel sheets, the thickness of the surface soft layer and the coating weight of the metal plating layer were measured. The results are listed in Table 5.

### [Thickness of Surface Soft Layer]

After smoothing a thickness cross-section (L cross-section) of the base steel sheet parallel to the rolling direction by wet polishing, measurements were taken using a Vickers hardness tester at a load of 10 gf, from a position of 1 μm in the thickness direction from the surface of the base steel sheet to a position of 100 μm in the thickness direction, at intervals of 1 μm.

Subsequently, measurements were taken at intervals of 20 μm up to the mid-thickness. The region where the hardness decreases to 85% or less compared to the hardness at the ¼ thickness position is defined as the soft layer (surface soft layer), and the thickness of that region in the thickness direction is taken as the thickness of the soft layer.

### [Coating Weight of Metal Plating Layer]

A sample with a size of 10 mm×15 mm was taken from the hot-dip galvanized steel sheet and embedded in resin to create a cross-sectional embedded sample. Using a scanning electron microscope (SEM) at an accelerating voltage of 15 kV, the thickness of the Fe-based coated or plated layer was observed at a magnification of 2000 to 10000 times at any three locations of the same cross-section, and the average thickness of the three fields of view was multiplied by the density of iron for conversion to the coating weight per side of the Fe-based coated or plated layer.

### [Nanohardness]

The nanohardness of the surface soft layer of the base steel sheet of the obtained hot-dip galvanized steel sheet was measured. The results are listed in Table 5.

For the ¼ position of the surface soft layer, the results are as follows. From the obtained hot-dip galvanized steel sheet, after plating removal, mechanical polishing was performed from the surface of the base steel sheet to the ¼ depth position in the thickness direction of the surface soft layer, followed by buff polishing with diamond and alumina, and colloidal silica polishing. Using a nanoindentation device (tribo-950 by Hysitron), a Berkovich-shaped diamond indenter was used to measure the nanohardness at a total of 512 points under the following conditions.

Loading speed and unloading speed: 50 μN/s

Maximum load: 500 μN

Measurement region: 50 μm×50 μm

Data acquisition pitch: 5 ms

Point interval: 2 μm

Next, mechanical polishing was performed up to the ½ depth position in the thickness direction of the surface soft layer, followed by buff polishing with diamond and alumina, and colloidal silica polishing. Using the tribo-950 by Hysitron, a Berkovich-shaped diamond indenter was used to measure the nanohardness at a total of 512 points the same set of conditions as above.

The hot-dip galvanized steel sheets were subjected to a U-bend+close-bend test, V-bend+orthogonal VDA bend test, and an axial crushing test. In consideration of the influence of sheet thickness, all of these tests were conducted using steel sheets with a thickness of 1.2 mm. Steel sheets thicker than 1.2 mm were ground on one side to achieve a thickness of 1.2 mm.

Since the bendability of the steel sheet surface may be affected by grinding, in the U-bend+close-bend test, the ground surface was on the inside of the bend (valley side), and in the V-bend+orthogonal VDA bend test, the ground surface was on the outside of the bend (mountain side) during the V-bend test, and then on the inside of the bend (valley side) during the subsequent VDA bend test. On the other hand, for the U-bend+close-bend test, V-bend+orthogonal VDA bend tests, and axial crushing test of galvanized steel sheets with a thickness of less than 1.2, the influence of thickness is small, and the tests were therefore conducted without grinding.

### [U-Bend+Close-Bend Test]

The U-bend+close-bend test was conducted as follows.

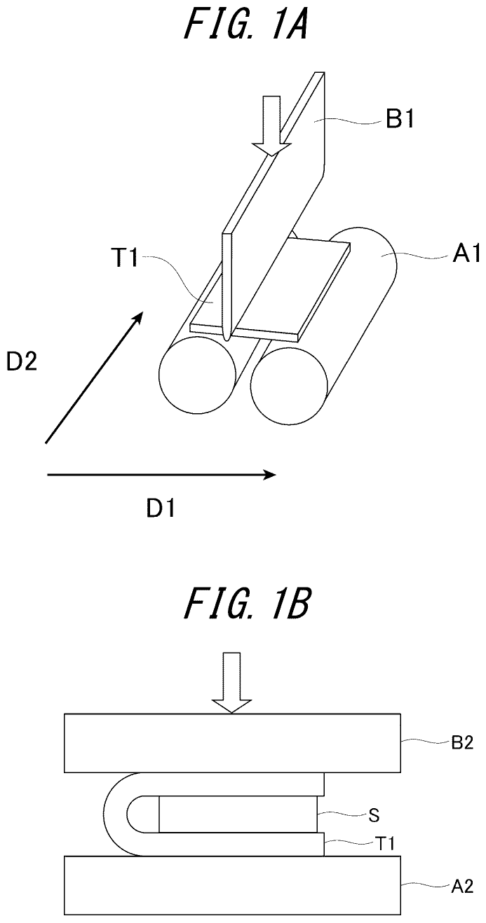

From the obtained galvanized steel sheets, a test piece of 60 mm×30 mm was collected by shearing and end-face grinding. Here, the 60 mm side is parallel to the width (C) direction. A test piece was prepared by performing U-bending (primary bending) in the width (C) direction with the rolling (L) direction as the axis at a curvature radius/sheet thickness of 4.2. In the U-bending (primary bending), as illustrated in FIG. 1A, the steel sheet placed on a roll A1 was pressed with a punch B1 to obtain a test piece T1. Next, as illustrated in FIG. 1B, the test piece Tl placed on a lower press mold A2 was subjected to close-bending (secondary bending) by being crushed with an upper press mold B2. In FIG. 1A, D1 indicates the width (C) direction, and D2 indicates the rolling (L) direction. A spacer S, which will be described later, is inserted between the test pieces.

The set of conditions for the U-bend in the U-bend+close-bend test are as follows.
Test method: roller support, punch pressing
Punch tip radius R: 5.0 mm
Clearance between roller and punch: sheet thickness+0.1 mm
Stroke speed: 10 mm/min
Bending direction: orthogonal to rolling (C) direction

The set of conditions for close bending in the U-bend+close-bend test are as follows.
Spacer thickness: changed at a 0.5 mm pitch
Test method: die support, punch pressing
Forming load: 10 tonnes
Test speed: 10 mm/min
Holding time: 5 s
Bending direction: orthogonal to rolling (C) direction

The U-bend+close-bend test was carried out three times, and the limit spacer thickness (ST) was determined when no cracks occurred in any of the three tests. Using a Leica stereomicroscope, a fissure longer than 200 μm at 25× magnification was judged to be a crack. ST serves as an indicator for evaluating the fracture resistance characteristics during collision (fracture resistance characteristics of the wall portion in the axial crushing test). The results are listed in Table 6.

The criteria for passing of the limit spacer thickness (ST) are as follows.
4.5 mm≥ST in the case of 980 MPa≤TS<1180 MPa
5.0 mm≥ST in the case of 1180 MPa≤TS<1320 MPa
5.5 mm≥ST in the case of 1320 MPa≤TS<1470 MPa
6.0 mm≥ST in the case of 1470 MPa≤TS

The criteria for failing of the limit spacer thickness (ST) are as follows.
4.5 mm<SFₘₐₓ in the case of 980 MPa≤TS<1180 MPa
5.0 mm<SFₘₐₓ in the case of 1180 MPa≤TS<1320 MPa
5.5 mm<SFₘₐₓ in the case of 1320 MPa≤TS<1470 MPa
6.0 mm<SFₘₐₓ in the case of 1470 MPa≤TS

### [V-Bend+Orthogonal VDA Bend Test]

The V-bend+orthogonal VDA bend test was conducted as follows.

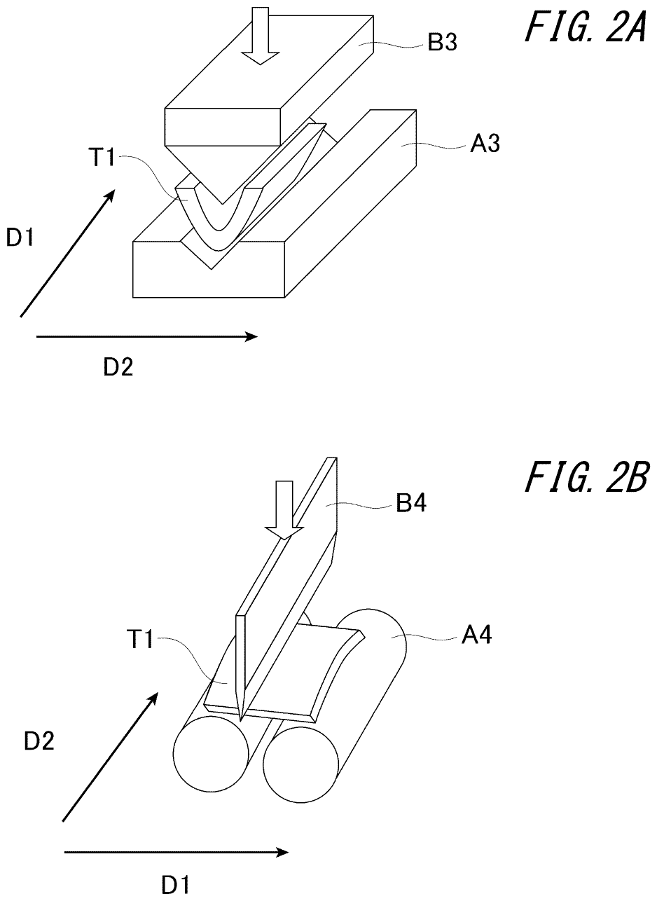

From the obtained hot-dip galvanized steel sheets, a test piece of 60 mm×65 mm was collected by shearing and end-face grinding. Here, the 60 mm side is parallel to the rolling (L) direction. A test piece was prepared by performing a 90° bending (primary bending) in the rolling (L) direction with the width (C) direction as the axis at a curvature radius/sheet thickness of 4.2. In the 90° bending process (primary bending), as illustrated in FIG. 2A, a punch B3 was pressed against the steel sheet placed on a die A3 with a V groove to obtain a test piece T1. Next, as illustrated in FIG. 2B, a punch B4 was pressed against the test piece Tl placed on a support roller A4, so that the bending direction was in the direction orthogonal to the rolling direction, to perform orthogonal bending (secondary bending). In FIGS. 2A and 2B, D1 indicates the width (C) direction, and D2 indicates the rolling (L) direction.

The conditions for the V-bend in the V-bend+orthogonal VDA bend test are as follows.
Test method: die support, punch pressing
Forming load: 10 tonnes
Test speed: 30 mm/min
Holding time: 5 s
Bending direction: rolling (L) direction

The conditions for VDA bending in the V-bend+orthogonal VDA bend test are as follows.
Test method: roller support, punch pressing
Roll diameter: φ30 mm
Punch tip radius R: 0.4 mm
Roll gap: (sheet thickness×2)+0.5 mm
Stroke speed: 20 mm/min
Test piece size: 60 mm×60 mm
Bending direction: orthogonal to rolling (C) direction

In the stroke-load curve obtained when the aforementioned VDA bending is applied, the stroke at maximum load is determined. The average value of the stroke at maximum load when conducting the V-bend+orthogonal VDA bend test three times was defined as SFₘₐₓ (mm). SFₘₐₓ serves as an indicator to evaluate the fracture resistance characteristics during collision (the fracture resistance characteristics of the bending ridge in the axial crushing test). The results are listed in Table 6.

The criteria for passing of SFₘₐₓ are as follows.
27.0 mm≤SFₘₐₓ in the case of 980 MPa≤TS<1180 MPa
26.0 mm≤SFₘₐₓ in the case of 1180 MPa≤TS<1320 MPa
24.5 mm≤SFₘₐₓ in the case of 1320 MPa≤TS<1470 MPa
24.0 mm≤SFₘₐₓ in the case of 1470 MPa≤TS

The criteria for failing of SFₘₐₓ are as follows.
27.0 mm>SFₘₐₓ in the case of 980 MPa≤TS<1180 MPa
26.0 mm>SFₘₐₓ in the case of 1180 MPa≤TS<1320 MPa
24.5 mm>SFₘₐₓ in the case of 1320 MPa≤TS<1470 MPa
24.0 mm>SFₘₐₓ in the case of 1470 MPa≤TS

### [Axial Crushing Test]

The axial crushing test was conducted as follows.

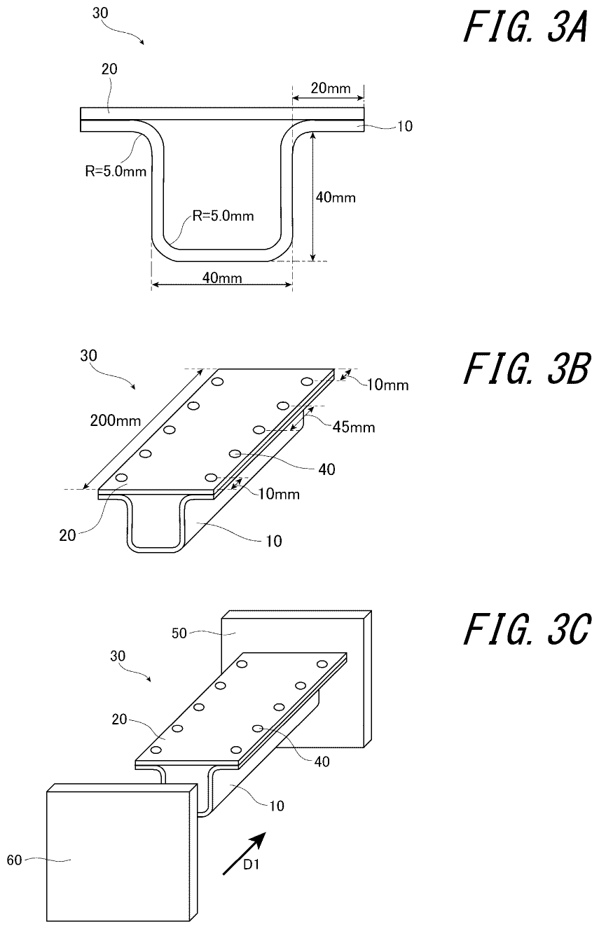

From the obtained hot-dip galvanized steel sheets, a test piece of 150 mm×100 mm was collected by shearing. Here, the 150 mm side is parallel to the rolling (L) direction. Using a press mold with a punch shoulder radius of 5.0 mm and a die shoulder radius of 5.0 mm, a forming process (bending process) was performed to achieve a depth of 40 mm, resulting in the production of the hat-shaped member 10 illustrated in FIGS. 3A and 3B.

Additionally, the steel sheet used as the material for the hat-shaped member was separately cut to a size of 80 mm×100 mm. Next, the cut steel sheet 20 and the hat-shaped member 10 were spot welded to create a test member 30 as illustrated in FIGS. 3A and 3B. FIG. 3A is a front view of the test member 30 created by spot welding the hat-shaped member 10 and the steel sheet 20. FIG. 3B is a perspective view of the test member 30. The positions of the spot welded portions 40 were set so that the distance between the end of the steel sheet and a welded portion was 10 mm, and the interval between the welded portions was 45 mm, as illustrated in FIG. 3B. Next, as illustrated in FIG. 3C, the test member 30 was joined to the base sheet 50 by TIG welding to create a sample for the axial crushing test. Next, the created sample for the axial crushing test was subjected to a constant speed collision with an impactor 60 at a collision speed of 10 mm/min, resulting in a 70 mm crushing of the sample for the axial crushing test. As illustrated in FIG. 3C, the crushing direction was set parallel to the longitudinal direction of the test member 30. The results are listed in Table 6.

The criteria for evaluating the presence of axial crushing fracture (appearance crack) are as follows.

A (Pass): No appearance cracks were observed in the sample after the axial crushing test.

B (Pass): One or fewer appearance cracks were observed in the sample after the axial crushing test.

C (Fail): Two or more appearance cracks were observed in the sample after the axial crushing test.

TABLE 4

| | | | | | | Annealing process | | | |
|---|---|---|---|---|---|---|---|---|---|
| | | | | | | Oxygen | | | |
| | | | Cold rolling process | | | concentra- | | | |
| | | | | Unit tension | | tion in | | | |
| | | Hot | | between final | First coating | temperature | | Retention | |
| | | rolling | | pass and | or plating | range of | | time in | Dew point in |
| | | process | | the pass | process | 250° C. or | | temperature | temperature |
| | | Coiling | Cumulative | immediately | Inclusion | more and | Annealing | range above | range above |
| | Steel | temper- | rolling | before the | of coating | 700° C. | temper- | 700° C. | 700° C. and |
| | sample | ature | reduction | final pass | or plating | or less | ature T₁ | and T₁ or | T₁ or less |
| No. | ID | (° C.) | ratio (%) | (kgf/mm²) | [type] | (volume %) | (° C.) | less (s) | (° C.) |
| 48 | B | 500 | 40 | 27 | No | 20 | 852 | 120 | −20 |
| 49 | B | 500 | 40 | 27 | No | 20 | 854 | 120 | 8 |
| 50 | B | 500 | 40 | 27 | Yes [Fe] | 20 | 848 | 120 | −20 |
| 51 | B | 500 | 40 | 27 | Yes [Fe] | 20 | 849 | 120 | 8 |
| 52 | B | 500 | 40 | 27 | Yes [Ni] | 20 | 853 | 120 | 8 |
| 53 | B | 500 | 40 | 27 | No | 20 | 850 | 120 | 8 |
| 54 | B | 500 | 40 | 27 | Yes [Fe] | 20 | 851 | 120 | −20 |
| 55 | B | 500 | 40 | 27 | Yes [Fe] | 20 | 846 | 120 | 8 |
| 56 | C | 600 | 50 | 27 | No | 20 | 800 | 90 | −10 |
| 57 | C | 600 | 50 | 27 | No | 20 | 801 | 90 | 5 |
| 58 | C | 600 | 50 | 27 | Yes [Fe] | 20 | 803 | 90 | −10 |
| 59 | C | 600 | 50 | 27 | Yes [Fe] | 20 | 803 | 90 | 5 |
| 60 | C | 600 | 50 | 27 | Yes [Ni] | 20 | 802 | 90 | 5 |
| 61 | C | 600 | 50 | 27 | No | 20 | 797 | 90 | 5 |
| 62 | C | 600 | 50 | 27 | Yes [Fe] | 20 | 802 | 90 | −10 |
| 63 | C | 600 | 50 | 27 | Yes [Fe] | 20 | 803 | 90 | 5 |
| 64 | N | 700 | 55 | 25 | No | 23 | 823 | 100 | −10 |
| 65 | N | 700 | 55 | 25 | No | 23 | 824 | 100 | 10 |
| 66 | N | 700 | 55 | 25 | Yes [Fe] | 23 | 816 | 100 | −10 |
| 67 | N | 700 | 55 | 25 | Yes [Fe] | 23 | 817 | 100 | 10 |
| 68 | N | 700 | 55 | 25 | Yes [Ni] | 23 | 819 | 100 | 10 |
| 69 | N | 700 | 55 | 25 | No | 23 | 822 | 100 | 10 |
| 70 | N | 700 | 55 | 25 | Yes [Fe] | 23 | 821 | 100 | −10 |
| 71 | N | 700 | 55 | 25 | Yes [Fe] | 23 | 822 | 100 | 10 |

| | | | | Reheating process | | | |
|---|---|---|---|---|---|---|---|
| | Cooling process | | | | Holding | | |
| | Holding | | | Reheating | time at | Coating | |
| | temper- | | Cooling stop | temper- | reheating | treatment | |
| | ature | Holding | temperature | ature | temper- | conditions | |
| No. | (° C.) | time (s) | (° C.) | (° C.) | ature (s) | Type | Notes |
| 48 | — | — | room | 250 | 70 | GA | Example |
| | | | temperature | | | | |
| 49 | — | — | room | 280 | 70 | GA | Example |
| | | | temperature | | | | |
| 50 | — | — | room | 280 | 70 | GA | Example |
| | | | temperature | | | | |
| 51 | — | — | room | 280 | 70 | GA | Example |
| | | | temperature | | | | |
| 52 | — | — | room | 280 | 70 | GA | Example |
| | | | temperature | | | | |
| 53 | — | — | room | 280 | 70 | GI | Example |
| | | | temperature | | | | |
| 54 | — | — | room | 280 | 70 | GI | Example |
| | | | temperature | | | | |
| 55 | — | — | room | 280 | 70 | GI | Example |
| | | | temperature | | | | |
| 56 | — | — | room | — | — | GA | Example |
| | | | temperature | | | | |
| 57 | — | — | room | — | — | GA | Example |
| | | | temperature | | | | |
| 58 | — | — | room | — | — | GA | Example |
| | | | temperature | | | | |
| 59 | — | — | room | — | — | GA | Example |
| | | | temperature | | | | |
| 60 | — | — | room | — | — | GA | Example |
| | | | temperature | | | | |
| 61 | — | — | room | — | — | GI | Example |
| | | | temperature | | | | |
| 62 | — | — | room | — | — | GI | Example |
| | | | temperature | | | | |
| 63 | — | — | room | — | — | GI | Example |
| | | | temperature | | | | |
| 64 | — | — | room | 200 | 100 | GA | Example |
| | | | temperature | | | | |
| 65 | — | — | room | 200 | 100 | GA | Example |
| | | | temperature | | | | |
| 66 | — | — | room | 200 | 100 | GA | Example |
| | | | temperature | | | | |
| 67 | — | — | room | 200 | 100 | GA | Example |
| | | | temperature | | | | |
| 68 | — | — | room | 200 | 100 | GA | Example |
| | | | temperature | | | | |
| 69 | — | — | room | 200 | 100 | GI | Example |
| | | | temperature | | | | |
| 70 | — | — | room | 200 | 100 | GI | Example |
| | | | temperature | | | | |
| 71 | — | — | room | 200 | 100 | GI | Example |
| | | | temperature | | | | |

Underlined values are outside of the range.

TABLE 5

| | | Steel microstructure of base steel sheet | | | | | | | | |
|---|---|---|---|---|---|---|---|---|---|---|
| | | | | | | Surface layer (region | | | | |
| | | | | | | up to depth of 10 μm) | | | | |
| | | | | | | | Ratio to the | | | |
| | | Thickness at ¼ position | | | | | area fraction | | | |
| | | Area | Area | Area | | Area | of M at ¼ | | Thickness | Metal |
| | Steel | ratio | ratio | ratio of | Residual | ratio | thickness | Residual | of surface | coating |
| | sample | of M | of α | retained | micro- | of M | position | micro- | layer soft | weight |
| No. | ID | (%) | (%) | γ (%) | structure | (%) | (%) | structure | layer (μm) | (g/m²) |
| 48 | B | 92 | 2 | 3 | θ | 51 | 55 | α + θ | 20 | — |
| 49 | B | 90 | 3 | 4 | θ | 51 | 57 | α + θ | 34 | — |
| 50 | B | 90 | 3 | 5 | θ | 51 | 57 | α + θ | 31 | 10.0 |
| 51 | B | 91 | 2 | 4 | θ | 51 | 56 | α + θ | 44 | 10.0 |
| 52 | B | 89 | 2 | 3 | θ | 51 | 57 | α + θ | 43 | 10.0 |
| 53 | B | 92 | 3 | 3 | θ | 51 | 55 | α + θ | 35 | — |
| 54 | B | 92 | 2 | 3 | θ | 51 | 55 | α + θ | 32 | 10.0 |
| 55 | B | 91 | 2 | 4 | θ | 51 | 56 | α + θ | 45 | 10.0 |
| 56 | C | 48 | 48 | 2 | θ | 30 | 62 | α + θ | 33 | — |
| 57 | C | 49 | 47 | 2 | θ | 30 | 61 | α + θ | 52 | — |
| 58 | C | 46 | 48 | 2 | θ | 30 | 65 | α + θ | 44 | 7.0 |
| 59 | C | 46 | 50 | 3 | θ | 30 | 65 | α + θ | 65 | 7.0 |
| 60 | C | 47 | 48 | 2 | θ | 30 | 64 | α + θ | 64 | 7.0 |
| 61 | C | 48 | 47 | 3 | θ | 30 | 62 | α + θ | 51 | — |
| 62 | C | 46 | 50 | 2 | θ | 30 | 65 | α + θ | 43 | 7.0 |
| 63 | C | 47 | 49 | 2 | θ | 30 | 64 | α + θ | 66 | 7.0 |
| 64 | N | 69 | 28 | 2 | θ | 41 | 59 | α + θ | 30 | — |
| 65 | N | 69 | 28 | 2 | θ | 41 | 59 | α + θ | 52 | — |
| 66 | N | 69 | 26 | 3 | θ | 41 | 59 | α + θ | 41 | 13.0 |
| 67 | N | 68 | 25 | 2 | θ | 41 | 60 | α + θ | 72 | 13.0 |
| 68 | N | 68 | 28 | 1 | θ | 41 | 60 | α + θ | 69 | 13.0 |
| 69 | N | 65 | 30 | 2 | θ | 41 | 63 | α + θ | 50 | — |
| 70 | N | 65 | 31 | 3 | θ | 41 | 63 | α + θ | 42 | 13.0 |
| 71 | N | 67 | 29 | 2 | θ | 41 | 61 | α + θ | 68 | 13.0 |

| | | | Surface nanohardness | | | | |
|---|---|---|---|---|---|---|---|
| | | Diffusible | | Standard | Standard | | |
| | | hydrogen | | deviation | deviation | | |
| | | content | | of Hn | of Hn | | |
| | | in low | | at ¼ | at ½ | | |
| | | temperature | | position | position | | |
| | | region | | of surface | of surface | | |
| | | of base | Ratio of | layer | layer | | |
| | Ultimate | steel | Hn of | soft | soft | | |
| | deform- | sheet | 7 GPa | layer | layer | | |
| No. | ability | (mass ppm) | or more | (GPa) | (GPa) | Type | Notes |
| 48 | 1.00 | 0.004 | 0.09 | 1.7 | 2.0 | GA | Example |
| 49 | 1.00 | 0.004 | 0.07 | 1.3 | 1.6 | GA | Example |
| 50 | 1.00 | 0.004 | 0.08 | 1.6 | 1.8 | GA | Example |
| 51 | 1.00 | 0.004 | 0.04 | 1.0 | 1.2 | GA | Example |
| 52 | 1.00 | 0.004 | 0.04 | 1.1 | 1.1 | GA | Example |
| 53 | 1.00 | 0.004 | 0.06 | 1.3 | 1.5 | GI | Example |
| 54 | 1.00 | 0.004 | 0.07 | 1.6 | 1.7 | GI | Example |
| 55 | 1.00 | 0.004 | 0.04 | 1.0 | 1.1 | GI | Example |
| 56 | 1.46 | 0.009 | 0.09 | 1.7 | 2.1 | GA | Example |
| 57 | 1.46 | 0.009 | 0.07 | 1.4 | 1.6 | GA | Example |
| 58 | 1.46 | 0.009 | 0.07 | 1.6 | 1.7 | GA | Example |
| 59 | 1.46 | 0.009 | 0.03 | 0.6 | 0.7 | GA | Example |
| 60 | 1.46 | 0.009 | 0.04 | 0.7 | 1.0 | GA | Example |
| 61 | 1.46 | 0.009 | 0.06 | 1.5 | 1.5 | GI | Example |
| 62 | 1.46 | 0.009 | 0.08 | 1.4 | 1.7 | GI | Example |
| 63 | 1.46 | 0.009 | 0.03 | 0.5 | 0.9 | GI | Example |
| 64 | 0.85 | 0.010 | 0.09 | 1.8 | 2.0 | GA | Example |
| 65 | 0.85 | 0.010 | 0.07 | 1.6 | 1.8 | GA | Example |
| 66 | 0.85 | 0.010 | 0.08 | 1.6 | 1.9 | GA | Example |
| 67 | 0.85 | 0.010 | 0.04 | 0.8 | 1.1 | GA | Example |
| 68 | 0.85 | 0.010 | 0.03 | 0.9 | 1.2 | GA | Example |
| 69 | 0.85 | 0.010 | 0.07 | 1.5 | 1.6 | GI | Example |
| 70 | 0.85 | 0.010 | 0.07 | 1.6 | 1.8 | GI | Example |
| 71 | 0.85 | 0.010 | 0.02 | 0.7 | 0.9 | GI | Example |

Underlined values are outside of the range.
M: martensite,
α: ferrite, retained
γ: retained austenite,
θ: cementite and/or metastable carbide

TABLE 6

| | | | | | | | | | | | V bend + | | |
|---|---|---|---|---|---|---|---|---|---|---|---|---|---|
| | | Mechanical properties | | | | | | | | U bend + | VDA | Axial | |
| | Steel | | | | | | TS × | | | close | bend | crushing | |
| | sample | YS | TS | El | L.El | TS × El | L.El | λ | | bending | SFₘₐₓ | charac- | |
| No. | ID | (MPa) | (MPa) | (%) | (%) | (MPa · %) | (MPa · %) | (%) | Bendability | ST (mm) | (mm) | teristics | Notes |
| 48 | B | 1100 | 1477 | 8 | 4 | 11816 | 5908 | 27 | excellent | 5.5 | 24.1 | B | Example |
| 49 | B | 1103 | 1482 | 9 | 5 | 13338 | 7410 | 30 | excellent | 4.5 | 25.3 | A | Example |
| 50 | B | 1098 | 1481 | 9 | 4 | 13329 | 5924 | 28 | excellent | 4.5 | 24.9 | A | Example |
| 51 | B | 1102 | 1487 | 8 | 4 | 11896 | 5948 | 31 | excellent | 4.0 | 26.5 | A | Example |
| 52 | B | 1098 | 1487 | 9 | 5 | 13383 | 7435 | 27 | excellent | 4.0 | 26.4 | A | Example |
| 53 | B | 1101 | 1483 | 8 | 4 | 11864 | 5932 | 30 | excellent | 4.5 | 25.2 | A | Example |
| 54 | B | 1105 | 1485 | 10 | 5 | 14850 | 7425 | 29 | excellent | 4.5 | 25.0 | A | Example |
| 55 | B | 1099 | 1485 | 9 | 4 | 13365 | 5940 | 28 | excellent | 4.0 | 26.5 | A | Example |
| 56 | C | 629 | 1036 | 19 | 8 | 19684 | 8288 | 23 | good | 3.5 | 27.3 | B | Example |
| 57 | C | 650 | 1045 | 18 | 7 | 18810 | 7315 | 25 | good | 2.5 | 28.2 | A | Example |
| 58 | C | 651 | 1045 | 18 | 7 | 18810 | 7315 | 24 | good | 2.5 | 27.8 | A | Example |
| 59 | C | 636 | 1039 | 17 | 8 | 17663 | 8312 | 23 | good | 1.5 | 29.0 | A | Example |
| 60 | C | 647 | 1043 | 18 | 7 | 18774 | 7301 | 26 | good | 1.5 | 28.8 | A | Example |
| 61 | C | 630 | 1054 | 17 | 7 | 17918 | 7378 | 25 | good | 2.5 | 28.1 | A | Example |
| 62 | C | 627 | 1045 | 19 | 7 | 19855 | 7315 | 23 | good | 3.0 | 27.9 | A | Example |
| 63 | C | 638 | 1031 | 17 | 7 | 17527 | 7217 | 24 | good | 1.5 | 28.7 | A | Example |
| 64 | N | 839 | 1208 | 8 | 5 | 9664 | 6040 | 40 | excellent | 4.0 | 26.7 | B | Example |
| 65 | N | 840 | 1205 | 9 | 5 | 10845 | 6025 | 44 | excellent | 3.0 | 27.2 | A | Example |
| 66 | N | 820 | 1217 | 10 | 6 | 12170 | 7302 | 42 | excellent | 3.5 | 27.1 | A | Example |
| 67 | N | 824 | 1203 | 9 | 6 | 10827 | 7218 | 39 | excellent | 2.5 | 27.9 | A | Example |
| 68 | N | 838 | 1218 | 9 | 6 | 10962 | 7308 | 46 | excellent | 2.5 | 27.8 | A | Example |
| 69 | N | 816 | 1200 | 8 | 5 | 9600 | 6000 | 45 | excellent | 3.0 | 27.3 | A | Example |
| 70 | N | 825 | 1203 | 10 | 6 | 12030 | 7218 | 42 | excellent | 3.5 | 27.0 | A | Example |
| 71 | N | 827 | 1215 | 8 | 5 | 9720 | 6075 | 40 | excellent | 2.5 | 27.9 | A | Example |

Underlined values are outside of the range.

As illustrated in Table 6, all of the Examples had a TS of 980 MPa or more, high ductility, high stretch flangeability, and bendability, along with high local ductility. On the other hand, for the Comparative Examples, at least one of TS, ductility, stretch flangeability, bendability, and local ductility was not sufficient. Furthermore, excellent fracture resistance characteristics during collision (bending fracture characteristics and axial crushing characteristics) were also exhibited.

Although embodiments of the present disclosure have been described above, the present disclosure is not limited to the above-described embodiments which form part of the present disclosure. That is, all other embodiments, examples, and operation techniques that a person skilled in the art can make based on the above embodiments fall within the scope of the present disclosure. For example, in the above-described series of heat treatment processes in the production method disclosed herein, any apparatus or the like may be used to perform the processes on the steel sheet as long as the thermal hysteresis conditions are met.

### INDUSTRIAL APPLICABILITY

According to the present disclosure, a hot-dip galvanized steel sheet, with a TS of 980 MPa or more, that has high ductility, high stretch flangeability, and bendability, as well as high local ductility, is obtained. In particular, the hot-dip galvanized steel sheet of the present disclosure has various excellent properties, making it applicable to automobile frame structural components of various sizes and shapes. This enables an improvement in fuel efficiency through automotive body weight reduction, which is of great industrial value.

REFERENCE SIGNS LIST

| | |
|---|---|
| 10 | Hat-shaped member |
| 20 | Galvanized steel sheet |
| 30 | Test member |
| 40 | Spot welded portion |
| 50 | Base sheet |
| 60 | Impactor |
| A1 | Die |
| A2 | Support roll |
| A3 | Die |
| A4 | Support roll |
| B1 | Punch |
| B2 | Punch |
| B3 | Punch |
| B4 | Punch |
| D1 | Width (C) direction |
| D2 | Rolling (L) direction |
| S | Spacer |
| T1 | Test piece |
| T2 | Test piece |

1. A hot-dip galvanized steel sheet comprising a base steel sheet and a hot-dip galvanized layer on a surface of the base steel sheet, wherein
the base steel sheet comprises
a chemical composition containing, in mass %,
C: 0.030% or more and 0.500% or less,
Si: 0.01% or more and 2.50% or less,
Mn: 0.10% or more and 5.00% or less,
P: 0.100% or less,
S: 0.0200% or less,
Al: 1.000% or less,
N: 0.0100% or less, and
O: 0.0100% or less,
with the balance being Fe and inevitable impurities, and
a steel structure such that at a ¼ thickness position of the base steel sheet,
an area ratio of martensite is 30% or more,
an area ratio of ferrite is 70% or less,
an area ratio of retained austenite is 10% or less,
at least one of ferrite and retained austenite is included, and
in a region up to a depth of 10 μm from the surface of the base steel sheet,
the area ratio of martensite is 5% or more, and the area ratio of martensite is 80% or less of the area ratio of martensite at the ¼ thickness position of the base steel sheet, and
a diffusible hydrogen content in a low temperature region within the base steel sheet is 0.015 mass ppm or less, the diffusible hydrogen content being an amount of hydrogen released when the base steel sheet is heated to 50° C.

2. The hot-dip galvanized steel sheet according to claim 1, wherein the chemical composition further contains, by mass %, at least one selected from the group consisting of:
Ti: 0.200% or less,
Nb: 0.200% or less,
V: 0.200% or less,
Ta: 0.10% or less,
W: 0.10% or less,
B: 0.0100% or less,
Cr: 1.00% or less,
Mo: 1.00% or less,
Ni: 1.00% or less,
Co: 0.010% or less,
Cu: 1.00% or less,
Sn: 0.200% or less,
Sb: 0.200% or less,
Ca: 0.0100% or less,
Mg: 0.0100% or less,
REM: 0.0100% or less,
Zr: 0.100% or less,
Te: 0.100% or less,
Hf: 0.10% or less, and
Bi: 0.200% or less.

3. The hot-dip galvanized steel sheet according to claim 1, wherein the hot-dip galvanized layer is a galvannealed layer.

4. The hot-dip galvanized steel sheet according to claim 1, wherein the base steel sheet comprises a surface soft layer that is a region having a Vickers hardness of 85% or less of a Vickers hardness at the ¼ thickness position of the base steel sheet and is a region within 200 μm from the surface of the base steel sheet in a thickness direction, and
when measuring nanohardness at 300 or more points in a 50 μm×50 μm region of a sheet surface at a ¼ depth position in the thickness direction and a ½ depth position in the thickness direction of the surface soft layer from the surface of the base steel sheet,
a ratio of a number of measurements with a nanohardness of the sheet surface of 7.0 GPa or more at the ¼ depth position in the thickness direction of the surface soft layer from the surface of the base steel sheet is 0.10 or less with respect to a total number of measurements,
a standard deviation σ of the nanohardness of the sheet surface at the ¼ depth position in the thickness direction of the surface soft layer from the surface of the base steel sheet is 1.8 GPa or less, and
a standard deviation σ of the nanohardness of the sheet surface at the ½ depth position in the thickness direction of the surface soft layer from the surface of the base steel sheet is 2.2 GPa or less.

5. The hot-dip galvanized steel sheet according to claim 1, comprising a metal coated or plated layer formed between the base steel sheet and the hot-dip galvanized layer on one side or both sides of the hot-dip galvanized steel sheet.

6. A member formed using the hot-dip galvanized steel sheet according to claim 1.

7. An automobile frame structural component or automobile reinforcement component comprising the member according to claim 6.

8. A method of producing a hot-dip galvanized steel sheet, the method comprising:
subjecting a steel slab having the chemical composition of claim 1 to hot rolling under a set of conditions including a coiling temperature of 400° C. or more and 700° C. or less to obtain a hot-rolled steel sheet;
subsequently subjecting the hot-rolled steel sheet to pickling;
subsequently subjecting the hot-rolled steel sheet to cold rolling under a set of conditions including a cumulative rolling reduction ratio of 30% or more and a unit tension of 10 kgf/mm² or more between a final pass and a pass immediately before the final pass to obtain a cold-rolled steel sheet;
subsequently heating the cold-rolled steel sheet to an annealing temperature T₁ of 750° C. or more and 950° C. or less with an oxygen concentration of 0.5 vol % or more and 5.0 vol % or less in a temperature range of 250° C. or more and 700° C. or less;
annealing the cold-rolled steel sheet under a set of conditions including setting a dew point to −30° C. or more in a temperature range above 700° C. and T₁ or less, and retaining the cold-rolled steel sheet for a retention time of 10 s or more and 500 s or less in the temperature range;
subsequently subjecting the cold-rolled steel sheet subjected to the annealing to hot-dip galvanizing treatment to obtain a coated steel sheet; and
subsequently cooling the coated steel sheet to obtain a hot-dip galvanized steel sheet.

9. The method of producing a hot-dip galvanized steel sheet according to claim 8, wherein during the cooling of the coated steel sheet, the coated steel sheet is held for 5 s or more in a temperature range of 100° C. or more and 450° C. or less and is then cooled.

10. The method of producing a hot-dip galvanized steel sheet according to claim 8, wherein during the cooling of the coated steel sheet, cooling is stopped at 300° C. or less, the coated steel sheet is subsequently reheated to a temperature range of cooling stop temperature+50° C. or more and 450° C. or less, is then held for 5 s or more, and is then cooled.

11. The method of producing a hot-dip galvanized steel sheet according to claim 8, wherein after the hot-dip galvanizing treatment, the coated steel sheet is subjected to alloying treatment.

12. The method of producing a hot-dip galvanized steel sheet according to claim 8, further comprising subjecting, before the annealing, one side or both sides of the cold-rolled steel sheet to metal coating or plating to form a metal coated or plated layer.

13. A method of producing a member, the method comprising subjecting the hot-dip galvanized steel sheet according to claim 1 to at least one of forming processing and joining processing to form a member.

14. The hot-dip galvanized steel sheet according to claim 2, wherein the hot-dip galvanized layer is a galvannealed layer.

15. The hot-dip galvanized steel sheet according to claim 2, wherein the base steel sheet comprises a surface soft layer that is a region having a Vickers hardness of 85% or less of a Vickers hardness at the ¼ thickness position of the base steel sheet and is a region within 200 μm from the surface of the base steel sheet in a thickness direction, and
when measuring nanohardness at 300 or more points in a 50 μm×50 μm region of a sheet surface at a ¼ depth position in the thickness direction and a ½ depth position in the thickness direction of the surface soft layer from the surface of the base steel sheet,
a ratio of a number of measurements with a nanohardness of the sheet surface of 7.0 GPa or more at the ¼ depth position in the thickness direction of the surface soft layer from the surface of the base steel sheet is 0.10 or less with respect to a total number of measurements,
a standard deviation σ of the nanohardness of the sheet surface at the ¼ depth position in the thickness direction of the surface soft layer from the surface of the base steel sheet is 1.8 GPa or less, and
a standard deviation σ of the nanohardness of the sheet surface at the ½ depth position in the thickness direction of the surface soft layer from the surface of the base steel sheet is 2.2 GPa or less.

16. A member formed using the hot-dip galvanized steel sheet according to claim 2.

17. An automobile frame structural component or automobile reinforcement component comprising the member according to claim 16.

18. A method of producing a hot-dip galvanized steel sheet, the method comprising:
subjecting a steel slab having the chemical composition of claim 2 to hot rolling under a set of conditions including a coiling temperature of 400° C. or more and 700° C. or less to obtain a hot-rolled steel sheet;
subsequently subjecting the hot-rolled steel sheet to pickling;
subsequently subjecting the hot-rolled steel sheet to cold rolling under a set of conditions including a cumulative rolling reduction ratio of 30% or more and a unit tension of 10 kgf/mm² or more between a final pass and a pass immediately before the final pass to obtain a cold-rolled steel sheet;
subsequently heating the cold-rolled steel sheet to an annealing temperature T₁ of 750° C. or more and 950° C. or less with an oxygen concentration of 0.5 vol % or more and 5.0 vol % or less in a temperature range of 250° C. or more and 700° C. or less;
annealing the cold-rolled steel sheet under a set of conditions including setting a dew point to −30° C. or more in a temperature range above 700° C. and T₁ or less, and retaining the cold-rolled steel sheet for a retention time of 10 s or more and 500 s or less in the temperature range;
subsequently subjecting the cold-rolled steel sheet subjected to the annealing to hot-dip galvanizing treatment to obtain a coated steel sheet; and
subsequently cooling the coated steel sheet to obtain a hot-dip galvanized steel sheet.

19. A method of producing a member, the method comprising subjecting the hot-dip galvanized steel sheet according to claim 2 to at least one of forming processing and joining processing to form a member.
